(19) United States
(12) Patent Application Publication
(10) Pub. No.: US 2025/0285248 A1
(43) Pub. Date: Sep. 11, 2025

(54) HIGH DYNAMIC RANGE IMAGE FORMAT WITH LOW DYNAMIC RANGE COMPATIBILITY

(71) Applicant: Google LLC, Mountain View, CA (US)

(72) Inventors: Nicholas DEAKIN, Mountain View, CA (US); Fares ALHASSEN, Mountain View, CA (US); Abraham J. STEPHENS, Mountain View, CA (US); Ryan GEISS, Mountain View, CA (US); Kiran Kumar MURTHY, Mountain View, CA (US); Emilian PEEV, Mountain View, CA (US)

(73) Assignee: Google LLC, Mountain View, CA (US)

(21) Appl. No.: 18/860,510

(22) PCT Filed: May 31, 2023
(86) PCT No.: PCT/US2023/023998

§ 371 Date: Oct. 25, 2024

Related U.S. Application Data
(60) Provisional application No. 63/421,155, filed on Oct. 31, 2022.
(60) Provisional application No. 63/439,271, filed on Jan. 16, 2023.

(51) Int. Cl. G06T 5/92; G06T 3/40

(52) U.S. Cl. CPC G06T 5/92; G06T 3/40; G06T 2207/20208

(57) ABSTRACT

Implementations relate to providing an HDR image format with low dynamic range compatibility. In some implementations, a computer-implemented method includes obtaining a first image depicting a scene and having a first dynamic range, obtaining a second image depicting the scene and having a second dynamic range that is different than the first dynamic range, and generating a recovery map based on the first and second images. The recovery map encodes differences in luminances between corresponding portions of the first and second images, the differences scaled by a range scaling factor including a ratio of maximum luminances of the second image and the first image. The first image and recovery map are provided in an image container that is readable to display a derived image that is based on applying the recovery map to the first image and has a dynamic range that is different than the first dynamic range.

### CROSS-REFERENCE TO RELATED APPLICATIONS

This application claims priority to U.S. Provisional Patent Application No. 63/421,155, filed Oct. 31, 2022 and titled HIGH DYNAMIC RANGE IMAGE FORMAT WITH LOW DYNAMIC RANGE COMPATIBILITY, and U.S. Provisional Patent Application No. 63/439,271, filed Jan. 16, 2023 and titled HIGH DYNAMIC RANGE IMAGE AND VIDEO FORMATS WITH LOW DYNAMIC RANGE COMPATIBILITY, the entire contents of both of which are incorporated by reference herein in their entirety.

### BACKGROUND

Users of devices such as smartphones or other digital camera devices capture and store a large number of photos in their image libraries. High dynamic range (HDR) images can be captured by some cameras, which offer a greater dynamic range and a more true-to-life picture quality than low dynamic range (LDR) images captured by many other (e.g., older) cameras. HDR images are best viewed by a display device capable of displaying the full dynamic ranges of the HDR images.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Implementations described herein relate to methods, devices, and computer-readable media to provide an HDR image format with low dynamic range compatibility. In some implementations, a computer-implemented method includes obtaining a first image depicting a particular scene, the first image having a first dynamic range; obtaining a second image depicting the particular scene, the second image having a second dynamic range that is different than the first dynamic range; and generating a recovery map based on the first image and the second image. The recovery map encodes differences in luminances between portions of the first image and corresponding portions of the second image, the differences scaled by a range scaling factor that includes a ratio of a maximum luminance of the second image to a maximum luminance of the first image. The first image and the recovery map are provided in an image container that is readable to display a derived image based on applying the recovery map to the first image, and the derived image has a dynamic range that is different than the first dynamic range.

Various implementations of the method are described. In some implementations, the second dynamic range is greater than the first dynamic range and the dynamic range of the derived image is greater than the first dynamic range. In some implementations, the image container is readable to display the first image by a first display device capable of displaying the first dynamic range, and to display the derived image by a second display device capable of displaying a dynamic range greater than the first dynamic range. In some implementations, obtaining the first image comprises performing range compression on the second image. In some implementations, generating the recovery map includes encoding luminance gains such that applying the luminance gains to luminances of individual pixels of the first image results in pixels corresponding to the second image. In some implementations, generating the recovery map can include encoding the luminance gains in a logarithmic space, and recovery map values are proportional to the difference of logarithms of the luminances divided by a logarithm of the range scaling factor. In some implementations, generating the recovery map is based on: recovery(x, y)=log(pixel_gain(x, y))/log(range scaling factor), where recovery(x,y) is the recovery map for pixel position (x, y) of the second image, and pixel_gain(x,y) is a ratio of luminances at the position (x, y) of the second image to the first image.

In some implementations of the method, generating the recovery map includes encoding the recovery map into a bilateral grid, which in some examples includes determining a three-dimensional data structure of grid cells, each grid cell being a vector element that is mapped to multiple pixels of the first image. In some implementations, the method further includes encoding the recovery map into a recovery image that is provided in the image container. In some implementations, the range scaling factor is encoded into the recovery image as metadata. In some implementations, the recovery image has the same aspect ratio as the aspect ratio of the first image.

In some implementations, the method further includes obtaining the image container; determining to display the second image by a display device; scaling a plurality of pixel luminances of the first image in the image container based on a particular luminance output of the display device and based on the recovery map to obtain the derived image; and after the scaling, causing the derived image to be displayed by the display device as an output image that has a greater dynamic range than the first image. In some implementations, the method includes determining a maximum luminance display capability of the display device, and the scaling of the pixel luminances includes increasing luminances of highlights in the first image to a luminance level that is less than or equal to the maximum luminance display capability. In some implementations, the luminances of the derived image are increased up to a maximum luminance of the second image. In some implementations, scaling the plurality of pixel luminances includes increasing a range of shadows in the first image to a level that the display device is capable of displaying.

In some implementations of the method, the second dynamic range is lower than the first dynamic range and the dynamic range of the derived image is lower than the first dynamic range. In some implementations, obtaining the second image comprises performing range compression on the first image. In some implementations, the image container is readable to display the first image by a first display device capable of displaying the first dynamic range, and to display the derived image by a second display device only capable of displaying a dynamic range lower than the first dynamic range.

In some implementations, a computer-implemented method includes obtaining an image container that includes a first image having a first dynamic range and a recovery map. The recovery map encodes luminance gains of pixels of the first image that are scaled by a range scaling factor that includes a ratio of a maximum luminance of a second image to a maximum luminance of the first image. The second image corresponds to the first image in depicted subject matter and has a second dynamic range that is different than the first dynamic range. The method determines whether to display one of: the first image or a derived image having a dynamic range greater than the first dynamic range. In response to determining to display the first image, the first image is caused to be displayed by a display device. In response to determining to display the derived image, the luminance gains of the recovery map are applied to luminances of pixels of the first image to determine respective corresponding pixel values of the derived image, and the derived image is caused to be displayed by the display device.

Various implementations of the method are described. In some implementations, the second dynamic range is greater than the first dynamic range and the dynamic range of the derived image is greater than the first dynamic range. In some implementations, the method includes determining a maximum luminance display capability of the display device. In some implementations, determining to display the first image is in response to determining that the display device is capable of displaying only a display dynamic range that is equal to or less than the first dynamic range. In some implementations, determining to display the derived image is in response to determining that the display device is capable of displaying a display dynamic range that is greater than the first dynamic range. In some implementations, the display device is capable of displaying a display dynamic range that is greater than the first dynamic range, and applying the gains of the recovery map includes adapting the luminances of the pixel values of the derived image to the display dynamic range of the display device.

In some implementations, the display device is capable of displaying a display dynamic range that is greater than the first dynamic range, and applying the gains of the recovery map includes adapting the luminances of the pixel values of the derived image to the display dynamic range of the display device. In some implementations, the dynamic range of the derived image has a maximum that is the lesser of: a maximum luminance of the display device, and a maximum luminance of a dynamic range of the second image.

In some implementations, applying the gains of the recovery map includes scaling the luminances of the first image based on a particular luminance output of the display device and based on the recovery map. In some implementations, the scaling of the luminances of the first image is performed based on: derived_image(x, y)=first_image(x, y)+log(display_factor)*recovery(x,y), where derived_image(x,y) is a logarithmic space version of the derived image, first_image(x,y) is a logarithmic space version of the first image recovered from the image container, display_factor is a minimum of: a range scaling factor and a maximum (or desired) display luminance of the display device, recovery(x,y) is the recovery map for pixel position (x, y) of the first image, and the range scaling factor is a ratio of a maximum luminance of the second image to a maximum luminance of the first image.

In some implementations, the method further includes, in response to determining to display the derived image, decoding the range scaling factor from the image container. In some implementations, the method further includes decoding the recovery map from a recovery image included in the image container. In some implementations, the method further includes extracting the recovery map from a bilateral grid stored in the image container.

In some implementations, determining whether to display one of: the first image or the derived image is performed by a server device, the determination based on a display dynamic range of the display device that is included in or coupled to a client device; causing the first image to be displayed by the display device includes sending the first image from the server device to the client device such that the client device displays the first image; and causing the derived image to be displayed by the display device includes sending the derived image from the server device to the client device such that the client device displays the derived image.

In some implementations, causing the derived image to be displayed by the display device includes reducing a maximum luminance level of the displayed derived image based on a system setting of a device that causes the derived image to be displayed, wherein the system setting is selected by a user. In some implementations, causing the derived image to be displayed by the display device includes: causing the derived image to be displayed with a first maximum luminance level that is below a second maximum luminance level determined for the pixel values of the derived image by applying the luminance gains, and gradually increasing the first maximum luminance level of the derived image over a particular period of time up to the second maximum luminance level.

In some implementations, a system includes a processor; and a memory coupled to the processor, with instructions stored thereon that, when executed by the processor, cause the processor to perform operations including obtaining an image container that includes a first image having a first dynamic range and a recovery map that encodes luminance gains of pixels of the first image. The method determines to display a derived image on a display device, wherein the derived image corresponds to the first image in depicted subject matter and has a dynamic range different than the first dynamic range. In response to determining to display the derived image on the display device, the gains of the recovery map are applied to luminances of pixels of the first image to determine respective corresponding pixel values of the derived image, and the luminances of the first image are scaled based on a particular luminance output of the display device and based on the recovery map. The derived image is caused to be displayed by the display device.

Various implementations of the system are described. In some implementations, the dynamic range of the derived image is greater than the first dynamic range, and the instructions cause the processor to perform operations further including determining a maximum luminance display capability of the display device, wherein determining to display the derived image is in response to determining that the display device is capable of displaying a display dynamic range that is greater than the first dynamic range. In some implementations, the dynamic range of the derived image has a maximum that is the lesser of: a maximum luminance of the display device, and a maximum luminance of a dynamic range of an original image used in generation of the recovery map. In some implementations, the recovery map encodes luminance gains of pixels of the first image that are scaled by a range scaling factor that includes a ratio of a maximum luminance of a second image to a maximum luminance of the first image, wherein the second image corresponds to the first image in depicted subject matter and has a second dynamic range that is greater than the first dynamic range. In some implementations, the processor performs further operations including extracting the recovery map from a bilateral grid stored in the image container. In some implementations, the system includes one or more of the operations and/or features of the methods described above.

Some implementations may include a computing device that includes a processor and a memory coupled to the processor. The memory has instructions stored thereon that, when executed by the processor, cause the processor to perform operations that include one or more of the operations and/or features of the methods described above.

Some implementations include a non-transitory computer-readable medium with instructions stored thereon that, when executed by a processor, cause the processor to perform operations that can be similar to operations and/or features of the methods, systems, and/or computing devices described above.

### BRIEF DESCRIPTION OF THE DRAWINGS

FIG. 1 is a block diagram of an example network environment which may be used for one or more implementations described herein.

FIG. 2 is a flow diagram illustrating an example method to encode an image in a backward-compatible high dynamic range image format, according to some implementations.

FIG. 3 is a flow diagram illustrating an example method to generate a recovery map based on an HDR image and an LDR image, according to some implementations.

FIG. 4 is a flow diagram illustrating an example method to encode a recovery map into a bilateral grid, according to some implementations.

FIG. 5 is a flow diagram illustrating an example method to decode an image of a backward-compatible high dynamic range image format and display an HDR image, according to some implementations.

FIGS. 6-9 are illustrations of example images representing a high dynamic range (FIG. 6) and a low dynamic range (FIGS. 7-9), according to some implementations.

FIG. 10 is a block diagram of an example computing device which may be used to implement one or more features described herein.

### DETAILED DESCRIPTION

This disclosure relates to backward-compatible HDR image formats. The image formats provide a container from which both low dynamic range (LDR) and high dynamic range (HDR) images can be obtained and displayed. The image formats can be used to display LDR versions of images by LDR display devices, and can be used to display HDR versions of the images by HDR display devices.

In some implementations, an image container is created that implements an image format. An image of lower dynamic range (e.g., an LDR image) and a corresponding image of greater (e.g., higher) dynamic range (e.g., an HDR image) are obtained. In some examples, the HDR image is captured by a camera, and the LDR image is created from the HDR image, e.g., using tone mapping or other process. The LDR image can be in a standard image format, such as JPEG or other format. A recovery map is generated based on the HDR and LDR images, that encodes differences (e.g., gains) in luminances between portions (e.g., pixels or pixel values) of the LDR image and corresponding portions (e.g., pixels or pixel values) of the HDR image, where the differences are scaled by a range scaling factor that includes a ratio of a maximum luminance of the HDR image to a maximum luminance of the LDR image. In some example implementations, the recovery map can be a scalar function, and encodes the luminance gains in a logarithmic space, where recovery map values are proportional to the difference of logarithms of the luminances divided by a logarithm of the range scaling factor. In some implementations, the recovery map can be encoded into a data structure or image representation that can reduce the storage space required to store the recovery map. For example, the data structure can be a bilateral grid, in which a three-dimensional data structure of grid cells is used. The recovery image and the LDR image are provided in an image container that can be stored, for example, as a new HDR image format.

The image container can be read and processed by a device to display an output image that is the LDR image or is an output HDR image (e.g., a derived image). A device that is to read and display the image stored in the described image format may use an LDR display device (e.g., display screen) that can display LDR images, e.g., it has a display dynamic range that can only display images up to the low dynamic range of LDR images, and cannot display greater dynamic ranges of HDR images. For such an LDR display device, the device accesses only the LDR image in the image container and ignores the recovery image. Since the LDR image is in a standard format, the device can readily display the image. Thus, in some implementations, the LDR image may still be displayed by a device that does not implement code to detect or apply the recovery image. If an accessing device can use a display device that is capable of displaying HDR images (e.g., can display a greater luminance range in its output than the maximum luminance of LDR images), the device accesses the LDR image and recovery map in the image container, and applies the luminance gains encoded in the recovery map to pixels of the LDR image to determine respective corresponding pixel values of an output HDR image that is to be displayed. In some examples, the device scales the pixel luminances of the LDR image based also on a luminance output of the HDR display device (e.g., a maximum luminance output of the display device) and as well as the luminance gains stored in the recovery map. The output HDR image is displayed on the HDR display device with a high dynamic range. In other implementations, an HDR image and a recovery map can be stored in the image container and the recovery map can be applied to the HDR image to obtain an LDR image having a lower dynamic range, which has a high visual quality due to being locally tone mapped via the recovery map.

Described features provided several technical advantages, including enabling efficient storage and high quality display of images with high dynamic range or images with lower (e.g., standard) dynamic range by a wide range of devices and using a single image format. For example, an image format is provided that allows any device to display an image having a dynamic range appropriate to its display capability. Further, the images displayed from these formats have no loss of visual quality (especially in their local contrast, e.g., detail) from converting from one dynamic range to another dynamic range. In various implementations, the output HDR image generated from the image container can be lossless, exact versions of the original HDR image that were used to create the image container, or the output HDR image can be a very similar version (visually) to the original HDR image, due to the recovery map storing the luminance information.

Described features can include using a recovery map to provide an output HDR image derived from an LDR image. The recovery map can include values based on a luminance gain ratio that is scaled by a range scaling factor, where the factor is a ratio of the maximum luminance of the original HDR image to the maximum luminance of the LDR image. For example, the recovery map indicates a relative amount to scale each pixel, and the range scaling factor indicates a specific amount of scaling to be performed, which provides context to the relative values in the recovery map (e.g., extending the range of the amount that pixels may be scaled for the particular image). The range scaling factor is advantageous in that it enables efficient, precise, and compact specification of recovery map values in a normalized range, which can then be efficiently adjusted for a particular output dynamic range using the range scaling factor. The use of the range scaling factor makes efficient use of all the bits used to store the recovery map, thus allowing encoding of a larger variety of images accurately.

Furthermore, in some implementations or cases, when displaying the output HDR image, the pixel luminances of the LDR image are also scaled based on a display factor. The display factor can be based on a luminance output of the HDR display device that is to display the output image. This allows an HDR image having any arbitrary dynamic range above LDR to be generated from the container based on the display capability of the display device. The dynamic range of the output HDR image is not constrained to any standard high dynamic range nor to the dynamic range of the original HDR image. Because HDR display devices may vary considerably as to how bright they can display images, a benefit of this feature is that an image can be displayed with a quality rendition on display devices of any dynamic range. Furthermore, described features allow changes in dynamic range (e.g., above LDR) in the output HDR image in real time based on user input or other conditions, e.g., to reduce viewing strain or fatigue in a user or for other applications. The display scaling allows an output HDR image to have an arbitrary dynamic range above the range of the LDR image.

In contrast, prior techniques may encode an HDR image for a display with a specific and fixed dynamic range or maximum brightness. Such a technique cannot take advantage of an HDR display device that has a greater dynamic range or brightness than the encoded dynamic range. In addition, such prior techniques may produce a lower quality image if the HDR display device is not capable of displaying as high a dynamic range as encoded in the original HDR image; for example, techniques such as rolloff curves may be required to reduce the dynamic range of the HDR image to display on the HDR display device, which, for example, often reduces local contrast in the image in undesirable ways, reducing the visual quality of the image.

Described features provide shareable, backwards-compatible mechanisms to create and render images that contain high dynamic range (HDR) content, beyond current formats. Described image formats can enable the next generation of consumer HDR content, and also allow supporting professional image workflows, in some implementations without the need for specialized hardware codecs for decoding/encoding. Also, one or more described implementations of HDR formats address issues with current HDR transfer functions that assume a global tone-mapping. In contrast, described features enable local tone-mapping, which is better at preserving details in scenes with varying levels of brightness. Thus, the described HDR formats can produce higher fidelity and quality HDR rendered content compared with traditional HDR formats.

In addition, described features allow the image format to have low storage requirements. For example, the image format allows a single LDR image to be stored with a recovery map that has low storage requirements, thus saving considerable storage space over a format that stores multiple full images. For example, some implementations include compressing the recovery map, and in some of these examples, the recovery map can be encoded into a bilateral grid. Such a grid can store the recovery map with a significant reduction in required storage space, and allows an output HDR image to be provided from the recovery map with almost no loss in visual quality compared to the original HDR image.

A technical effect of one or more described implementations is that devices can display images having a dynamic range that better corresponds to the dynamic range of a particular output display device that is being used to display the images, as compared to prior systems. For example, such a prior system may provide an image that does not have a dynamic range that corresponds to the dynamic range of a display device, resulting in poorer image display quality. Features described herein can reduce such disadvantages by, e.g., providing a recovery map in the image format, and/or scaling image output, to set the dynamic range of an image to better suit a particular display device. Furthermore, a technical effect of one or more described implementations is that devices expend fewer computational resources to obtain results. For example, a technical effect of described techniques is a reduction in the consumption of system processing resources and/or storage resources as compared to prior systems that do not provide one or more of the described techniques or features. For example, a prior system may require a full LDR image, and a full HDR image to be stored and/or provided in order to display an image that has an appropriate dynamic range for a particular display device, which requires additional storage and communication bandwidth resources in comparison to described techniques. In another example, a prior system may only store an HDR image, and then rely on tone-mapping the HDR image to a lower dynamic range for LDR display; such tone mapping may reduce visual quality in representing the HDR image on a LDR display for a large variety of HDR images.

As referred to herein, dynamic range relates to a ratio between the brightest and darkest parts of a scene. The dynamic range of LDR formats typically does not exceed a particular low range, such as a standard dynamic range (SDR) file in a low range color space/color profile. Similarly, the displayed dynamic range output of LDR display devices is low. As referred to herein, an image with dynamic range greater (or higher) than an LDR image (e.g., JPEG) is considered an HDR image, and a display device capable of displaying that greater dynamic range is considered an HDR display device. An HDR image can store pixel values that span a greater tonal range than LDR. In some examples, an HDR image can more accurately display the dynamic range of a real-world scene, and/or may have a lower dynamic range that is greater than the dynamic range of an LDR image (e.g., HDR images may commonly have greater than 8 bits per color channel).

The use of “log” in this description refers to a particular base of logarithm, and can be any base number, e.g., all logs herein can be base 2, or base 10, etc.

Further to the descriptions herein, a user may be provided with controls allowing the user to make an election as to both if and when systems, programs, or features described herein may enable collection of user information (e.g., images from a user's library, social network, social actions, or activities, profession, a user's preferences, a user's current location, a user's messages, or characteristics of a user's device), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

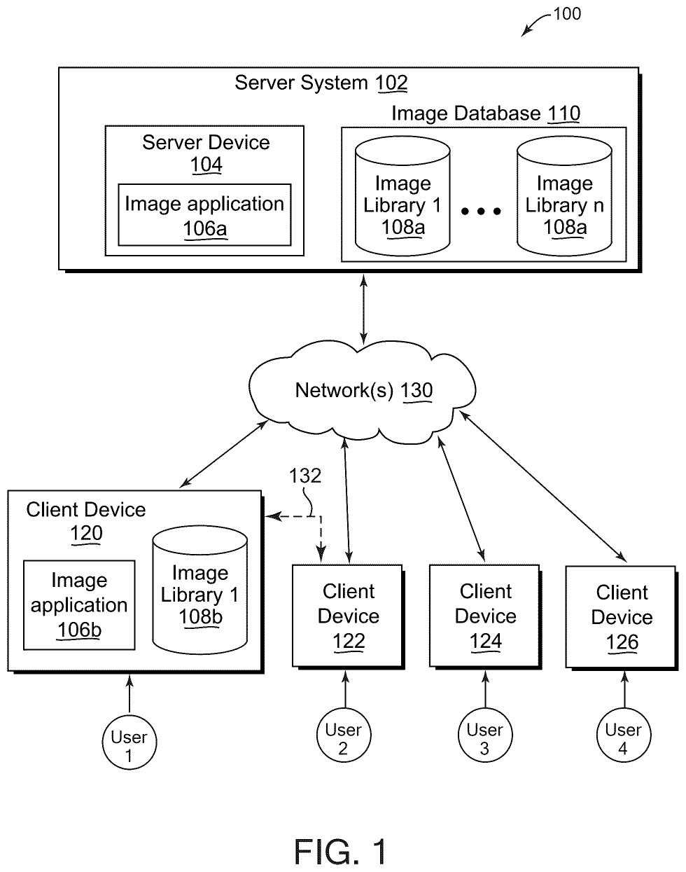

FIG. 1 illustrates a block diagram of an example network environment 100, which may be used in some implementations described herein. In some implementations, network environment 100 includes one or more server systems, e.g., server system 102 in the example of FIG. 1, and a plurality of client devices, e.g., client devices 120-126, each associated with a respective user of users U1-U4. Each of server system 102 and client devices 120-126 may be configured to communicate with a network 130.

Server system 102 can include a server device 104 and an image database 110. In some implementations, server device 104 may provide image application 106a. In FIG. 1 and the remaining figures, a letter after a reference number, e.g., “106a,” represents a reference to the element having that particular reference number. A reference number in the text without a following letter, e.g., “106,” represents a general reference to embodiments of the element bearing that reference number.

Image database 110 may be stored on a storage device that is part of server system 102. In some implementations, image database 110 may be implemented using a relational database, a key-value structure, or other type of database structure. In some implementations, image database 110 may include a plurality of partitions, each corresponding to a respective image library for each of users 1-4. For example, as seen in FIG. 1, image database 110 may include a first image library (image library 1, 108a) for user 1, and other image libraries (image library 2, . . . , image library n) for various other users. While FIG. 1 shows a single image database 110, it may be understood that image database 110 may be implemented as a distributed database, e.g., over a plurality of database servers. Further, while FIG. 1 shows a plurality of partitions, one for each user, in some implementations, each image library may be implemented as a separate database.

Image library 108a may store a plurality of images (including videos) associated with user 1, metadata associated with the plurality of images, and one or more other database fields, stored in association with the plurality of images. Access permissions for image library 108a may be restricted such that user 1 can control how images and other data in image library 108a may be accessed, e.g., by image application 106, by other applications, and/or by one or more other users. Server system 102 may be configured to implement the access permissions, such that image data of a particular user is accessible only as permitted by the user.

An image as referred to herein can include a digital image having pixels with one or more pixel values (e.g., color values, brightness values, etc.). An image can be a still image (e.g., still photos, images with a single frame, etc.), a dynamic image (e.g., animations, animated GIFs, cinemagraphs where a portion of the image includes motion while other portions are static, etc.), or a video (e.g., a sequence of images or image frames that may optionally include audio). An image as used herein may be understood as any of the above. For example, implementations described herein can be used with still images (e.g., a photograph, or other image), videos, or dynamic images.

Network environment 100 can include one or more client devices, e.g., client devices 120, 122, 124, and 126, which may communicate with each other and/or with server system 102 via network 130. Network 130 can be any type of communication network, including one or more of the Internet, local area networks (LAN), wireless networks, switch or hub connections, etc. In some implementations, network 130 can include peer-to-peer communication between devices, e.g., using peer-to-peer wireless protocols (e.g., Bluetooth®, Wi-Fi Direct, etc.), etc. One example of peer-to-peer communication between two client devices 120 and 122 is shown by arrow 132.

In various implementations, users 1, 2, 3, and 4 may communicate with server system 102 and/or each other using respective client devices 120, 122, 124, and 126. In some examples, users 1, 2, 3, and 4 may interact with each other via applications running on respective client devices and/or server system 102 and/or via a network service, e.g., a social network service or other type of network service, implemented on server system 102. For example, respective client devices 120, 122, 124, and 126 may communicate data to and from one or more server systems, e.g., server system 102.

In some implementations, the server system 102 may provide appropriate data to the client devices such that each client device can receive communicated content or shared content uploaded to the server system 102 and/or a network service. In some examples, users 1-4 can interact via image sharing, audio or video conferencing, audio, video, or text chat, or other communication modes or applications.

A network service implemented by server system 102 can include a system allowing users to perform a variety of communications, form links and associations, upload and post shared content such as images, text, audio, and other types of content, and/or perform other functions. For example, a client device can display received data such as content posts sent or streamed to the client device and originating from a different client device via a server and/or network service (or from the different client device directly), or originating from a server system and/or network service. In some implementations, client devices can communicate directly with each other, e.g., using peer-to-peer communications between client devices as described above. In some implementations, a “user” can include one or more programs or virtual entities, as well as persons that interface with the system or network.

In some implementations, any of client devices 120, 122, 124, and/or 126 can provide one or more applications. For example, as shown in FIG. 1, client device 120 may provide image application 106b. Client devices 122-126 may also provide similar applications. Image application 106a may be implemented using hardware and/or software of client device 120. In different implementations, image application 106a may be a standalone client application, e.g., executed on any of client devices 120-124, or may work in conjunction with image application 106b provided on server system 102.

Image application 106 may provide various features, implemented with user permission, that are related to images (including videos). For example, such features may include one or more of capturing images using a camera, modifying the images, determining image quality (e.g., based on factors such as face size, blurriness, number of faces, image composition, lighting, exposure, etc.), storing images in an image library 108, encoding and decoding images and videos into any of various image and video formats (including formats described herein), providing user interfaces to view displayed images or image-based creations or compilations, etc.

Client device 120 may include an image library 108b of user 1, which may be a standalone image library. In some implementations, image library 108b may be usable in combination with image library 108a on server system 102. For example, with user permission, image library 108a and image library 108b may be synchronized via network 130. In some implementations, image library 108 may include a plurality of images associated with user 1, e.g., images captured by the user (e.g., using a camera of client device 120, or other device), images shared with the user 1 (e.g., from respective image libraries of other users 2-4), images downloaded by the user 1 (e.g., from websites, from messaging applications, etc.), screenshots, and other images. In some implementations, image library 108b on client device 120 may include a subset of images in image library 108a on server system 102. For example, such implementations may be advantageous when a limited amount of storage space is available on client device 120.

In various implementations, client device 120 and/or server system 102 may include other applications (not shown) that may be applications that provide various types of functionality. A user interface on a client device 120, 122, 124, and/or 126 can enable the display of user content and other content, including images, image-based creations, data, and other content as well as communications, privacy settings, notifications, and other data. Such a user interface can be displayed using software on the client device, software on the server device, and/or a combination of client software and server software executing on server device 104, e.g., application software or client software in communication with server system 102. The user interface can be displayed by a display device of a client device or server device, e.g., a touchscreen or other display screen, projector, etc. In some implementations, application programs running on a server system can communicate with a client device to receive user input at the client device and to output data such as visual data, audio data, etc. at the client device.

For ease of illustration, FIG. 1 shows one block for server system 102, server device 104, image database 110, and shows four blocks for client devices 120, 122, 124, and 126. Server blocks 102, 104, and 110 may represent multiple systems, server devices, and network databases, and the blocks can be provided in different configurations than shown. For example, server system 102 can represent multiple server systems that can communicate with other server systems via the network 130. In some implementations, server system 102 can include cloud hosting servers, for example. In some examples, image database 110 may be stored on storage devices provided in server system block(s) that are separate from server device 104 and can communicate with server device 104 and other server systems via network 130.

Also, there may be any number of client devices. Each client device can be any type of electronic device, e.g., desktop computer, laptop computer, portable or mobile device, cell phone, smartphone, tablet computer, television, TV set top box or entertainment device, wearable devices (e.g., display glasses or goggles, wristwatch, headset, armband, jewelry, etc.), personal digital assistant (PDA), media player, game device, etc. In some implementations, network environment 100 may not have all of the components shown and/or may have other elements including other types of elements instead of, or in addition to, those described herein.

Other implementations of features described herein can use any type of system and/or service. For example, other networked services (e.g., connected to the Internet) can be used instead of or in addition to a social networking service. Any type of electronic device can make use of features described herein. Some implementations can provide one or more features described herein on one or more client or server devices disconnected from or intermittently connected to computer networks. In some examples, a client device including or connected to a display device can display content posts stored on storage devices local to the client device, e.g., received previously over communication networks.

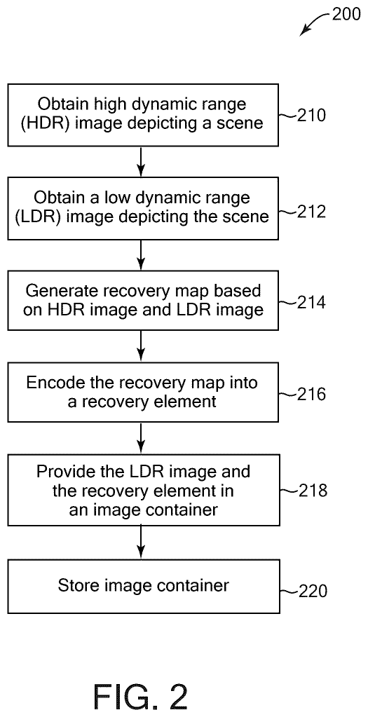

FIG. 2 is a flow diagram illustrating an example method 200 to encode an image in a backward-compatible high dynamic range image format, e.g., an HDR image format that has low dynamic range compatibility, according to some implementations. In some implementations, method 200 can be performed, for example, on a server system 102 as shown in FIG. 1. In some implementations, some or all of the method 200 can be implemented on one or more client devices such as client devices 120, 122, 124, or 126 of FIG. 1, one or more server devices such as server device 104 of FIG. 1, and/or on both server device(s) and client device(s). In described examples, the implementing system includes one or more digital processors or processing circuitry (“processors”), and one or more storage devices (e.g., a database or other storage). In some implementations, different components of one or more servers and/or clients can perform different blocks or other parts of the method 200. In some examples, a device is described as performing blocks of method 200. Some implementations can have one or more blocks of method 200 performed by one or more other devices (e.g., other client devices or server devices) that can send results or data to the first device.

In some implementations, the method 200, or portions of the method, can be initiated automatically by a system. For example, the method (or portions thereof) can be performed periodically, or can be performed based on one or more particular events or conditions, e.g., a client device launching image application 106, capture of new images by an image capture device of a client device, reception of images over a network by a device, upload of new images to a server system 102, a predetermined time period having expired since the last performance of method 200, and/or one or more other conditions occurring which can be specified in settings read by the method.

User permissions can be obtained to use user data in method 200 (blocks 210-220). For example, user data for which permission is obtained can include images stored on a client device (e.g., any of client devices 120-126) and/or a server device, image metadata, user data related to the use of an image application, other image-based creations, etc. The user is provided with options to selectively provide permission to access all, any subset, or none of user data. If user permission is insufficient for particular user data, method 200 can be performed without use of that of user data, e.g., using other data (e.g., images not having an association with the user).

Method 200 may begin at block 210. In block 210, a high dynamic range (HDR) image is obtained by the device (an “original HDR image”), the HDR image depicting a particular scene. In some implementations, the HDR image is provided in any of multiple standard formats for high dynamic range images. In some examples, the HDR image can be captured by an image capture device, e.g., a camera of a client device or other device. In additional examples, the HDR image is received over a network from a different device, or obtained from storage accessible by the device. In some implementations, the HDR image can be generated based on any of multiple image generation techniques, e.g., ray tracing, etc.

In block 212, a low dynamic range (LDR) image is obtained by the device (e.g., an “original LDR image”), the LDR image depicting the same scene and/or subject matter as the HDR image, e.g., corresponds to the HDR image in depicted subject matter. The LDR image has a lower dynamic range than the HDR image. In some implementations, the LDR image can have a dynamic range of a standard LDR image format, or can have any lower dynamic range than the HDR image. For example, the LDR image can be provided in a standard image format, e.g., JPEG, AV1 Image File Format (AVIF), TIFF, etc. In some examples, the LDR image has a dynamic range that is provided in 8 bits per pixel per channel, and the HDR image has a dynamic range above the dynamic range of the LDR image (e.g., commonly a bit depth that is 10 bits or greater, a wide-gamut color space, and HDR-oriented transfer functions).

In various implementations, the HDR image of block 210 can be obtained before or can be obtained after the LDR image is obtained. For example, in some implementations, an HDR image is obtained, and the LDR image is derived from the HDR image. In some examples, the LDR image can be generated based on the HDR image using local tone mapping or other process. Local tone mapping, for example, changes each pixel according to its local features of the image(not according to a global tone mapping function that changes each pixel the same way). Any of a variety of local tone mapping techniques can be used to reduce tonal values within the HDR image to be appropriate for the LDR image having a lower dynamic range. For example, local Laplacian filtering can be used in the tone mapping process, and/or other techniques can be used. In some implementations, a different global tone-curve (or digital gain) can be used in different areas of the image. In some implementations, different tone mapping techniques can be used for different types of image data, e.g., different techniques for still images and for video images. In other examples, exposure fusion techniques can be used to produce the LDR image from the HDR image and/or from multiple captured or generated images, e.g., combining portions of multiple images captured or synthetically generated at different exposure levels, into a combined LDR image that includes these portions. In some example implementations, a combination of tone mapping and exposure fusion techniques can be used to produce the LDR image (e.g., use Laplacian tone mapping pyramids from different images having different exposure levels, provide a weighted blend of the pyramids, and collapse the blended pyramid).

In other examples, the LDR image can be obtained from other sources. For example, the HDR image can be captured by a camera device and the LDR image can be captured by the same camera device, e.g., immediately before or after, or at least partially simultaneously with, the capture of the HDR image. In some examples, the camera device can capture the HDR image and LDR image based on camera settings, e.g., with dynamic ranges indicated in the camera settings or user-selected settings. Block 212 may be followed by block 214.

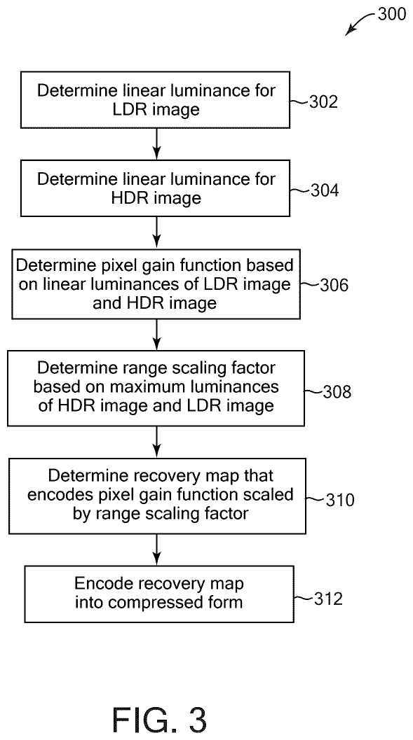

In block 214, a recovery map is generated based on the HDR image and the LDR image. The recovery map encodes differences in luminances between portions (e.g. pixels) of the HDR image and corresponding portions (e.g., pixels) of the LDR image. The recovery map is to be used to convert luminances of the LDR image into luminances of the HDR image. For example, luminance gains and a range scaling factor can be encoded in the recovery map, so that applying the luminance gains to luminance values of individual pixels of the LDR image results in corresponding pixels of the HDR image. Examples of generating a recovery map are described in greater detail below with reference to FIG. 3. Block 214 may be followed by block 216.

In block 216, the recovery map can be encoded into a recovery element. In various implementations, the recovery element can be an image, data structure, algorithm, neural network, etc. that includes or provides the recovery map information. For example, the recovery element can be a recovery image that is compressed into a standard format and has the same aspect ratio as an aspect ratio of the LDR image. The recovery image can have any resolution, e.g., the same or a different resolution than the LDR image. For example, the recovery image can have a smaller resolution than the LDR image, e.g., one quarter the resolution of the LDR image (e.g., a 480×270 recovery image for a 1920×1080 LDR image).

In some examples, the recovery image can be encoded as single channel 8-bit unsigned integer values, where each value represents a recovery value and is stored in one pixel of the recovery image. In some example implementations, the encoding can result in a continuous representation from −2.0 to 2.0 that can be compressed, e.g., JPEG compressed. In some implementations, the encoding can include 1 bit to indicate if the map value is positive or negative and the rest of the bits interpreted as the magnitude of the value in the range of recovery map values (e.g., −1 to +1). In some implementations, such as this example, the magnitude representation can exceed 1.0 and −1.0, since some pixels may require greater attenuation or gain than represented by the range scaling factor to accurately recover or represent the original HDR image luminance range.

In the single-channel encoding, the channel can specify an adjustment to make to a target image based on luminance (brightness). Thus, chromaticity or hue of the target image would not be changed during the application of the recovery map to that image. Single channel encoding can preserve existing chromaticity or hue of the target image (e.g., preserve RGB ratios), and typically requires less storage space than multi-channel encoding. In some implementations, the recovery image can be encoded as multi-channel values. Multi-channel encoding can allow adjustment of the colors (e.g., chromaticity or hue) of the target image during the application of the recovery map to the target image. Multi-channel encoding can compensate for loss of colors that may have occurred in the LDR image, e.g., rolloff of color at high brightness. This can allow recovery of HDR luminance as well as correct color (for example, instead of only increasing the brightness that causes the sky to look white, also resaturating the sky to a blue hue). In some implementations, a multi-channel encoded recovery map can be used to recover a wider color gamut (or compensate for a loss of color gamut) in the target image. For example, an ITU-R Recommendation BT.2020 gamut can be recovered from a standard RGB (sRGB)/BT.709 gamut LDR image.

In some implementations, a different bit-depth, e.g., a bit-depth greater than 8-bit, can be used for the recovery map values. For example, in some implementations, 8-bit depth may be a minimum bit-depth to allow for HDR representation in combination with an 8-bit single channel gain map, where a lower bit depth may not provide enough information to provide HDR image content without artifacts such as banding. In some implementations, the recovery image can be encoded as floating point values instead of integers. In some implementations, the recovery element can be a data structure, algorithm, neural network, etc. that encodes the values of the recovery map. For example, the recovery map can be encoded in weights of a small neural network that is used as the recovery element. Block 216 may be followed by block 218.

In block 218, the LDR image and the recovery element are provided in an image container that can be stored as a new HDR image format. In some implementations, the LDR image can be considered a base image in the image container. The image container can be read by a device to display the LDR image or HDR image. In some implementations, the image container can be a standard image container, e.g., an AVIF (AV1 Image File Format) image container.

In some implementations, the recovery map can be quantized into a precision of the image container into which the recovery map is to be placed. For example, in some implementations in which the LDR image is a JPEG image(or other format in which 8-bit unsigned integer values are used), the values of the recovery map can be quantized into an 8-bit format for storage. In some examples, each value can represent a recovery value and is stored in one pixel of a recovery image. In some examples, each encoded value can be defined as:

$$encode ( x , y ) = recovery ( x , y ) * 63.75 + 127.5$$

This encoding results in a representation in a range from −2.0 to 2.0, with each value quantized to one of the 256 possible encoded values, for example. Other ranges and quantizations can be used in other implementations, e.g., −1.0 to 1.0 or other ranges.

The image container can include additional information that relates to the display of an output HDR image that is based on the contents of the image container. For example, the additional information can include metadata that is provided in the image container, in the recovery element, and/or in the LDR image. Metadata can encode information about how to present the LDR image, and/or an HDR image derived therefrom, on a display device. Such metadata can include, for example, the version of recovery map format used in the container, the range scaling factor used in the recovery map, a storage method (e.g., whether the recovery map is encoded in a bilateral grid or other data structure, or is otherwise compressed by a specified compression technique), resolution of the recovery map and/or recovery image, guide weights for bilateral grid storage, and/or other recovery map properties or image properties.

In some examples, the LDR image can include a metadata data structure or directory that defines the order and properties of the items (e.g., files) in the image container, and each file in the container can have a corresponding media item in the data structure. The media item can describe the location of the associated file in the image container and basic properties of the associated file. For example, a container element can be encoded into metadata of the LDR image, where the element defines the format version and a data structure of media items in the container. In some examples, metadata is stored according to a data model that allows the LDR image to be read by devices or applications that do not support the metadata and cannot read it. For example, the metadata can be stored in the recovery image and/or the LDR image according to the Extensible Metadata Platform (XMP) data mode. Block 218 may be followed by block 220.

In block 220, the image container can be stored, e.g., in storage for access by one or more devices. For example, the image container can be sent to one or more server systems over a network to be made accessible to multiple client devices that can access the server systems.

In some implementations, a server device can save the image container in cloud storage (or other storage) that includes the additional information such as metadata. The server can store the LDR image in any format in the container. In response to the server device receiving a request for the image from a client device, the server device can determine which image data to serve to the requesting client device based on system settings, user preferences, characteristics of the client device such as type of client device (e.g., mobile client device, desktop computer client device), display device characteristics of the client device such as dynamic range, resolution, etc. For example, for some client devices, the server device can serve the image container to the client device, and the client device can decode the image container to obtain an image to display (base image or derived image) in the appropriate dynamic range for the client's display device. For other client devices (e.g., for which the server device has information describing client device characteristics, such as dynamic range of the display device of the client device), the server device can extract and decode an image from the image container and serve the image to the client device, where the served image has an appropriate dynamic range for the client's display device as determined by the server device. In some implementations, the server device can determine the base image and derived image from the image container and serve both images to the client device, and the client device can select which of these images to display based on the dynamic range of its display device.

In some implementations, multiple recovery maps (e.g., recovery elements) can be included in the image container. Each recovery map can include different values to provide one or more different characteristics to an output image that is based on the recovery map as described herein. For example, a particular one of the multiple recovery maps can be selected and applied to provide an output image having characteristics based on the selected recovery map and, e.g., thus may be more suited to a particular use or application than the other recovery map(s) in the image container. For example, some or all of the multiple recovery maps can be associated with particular and different physical display device characteristics of a target output display device. In some examples, a user may select to use different recovery maps to display LDR or HDR images on display devices with different dynamic ranges (e.g., different peak brightnesses) or different color gamuts, or when using different image decoders.

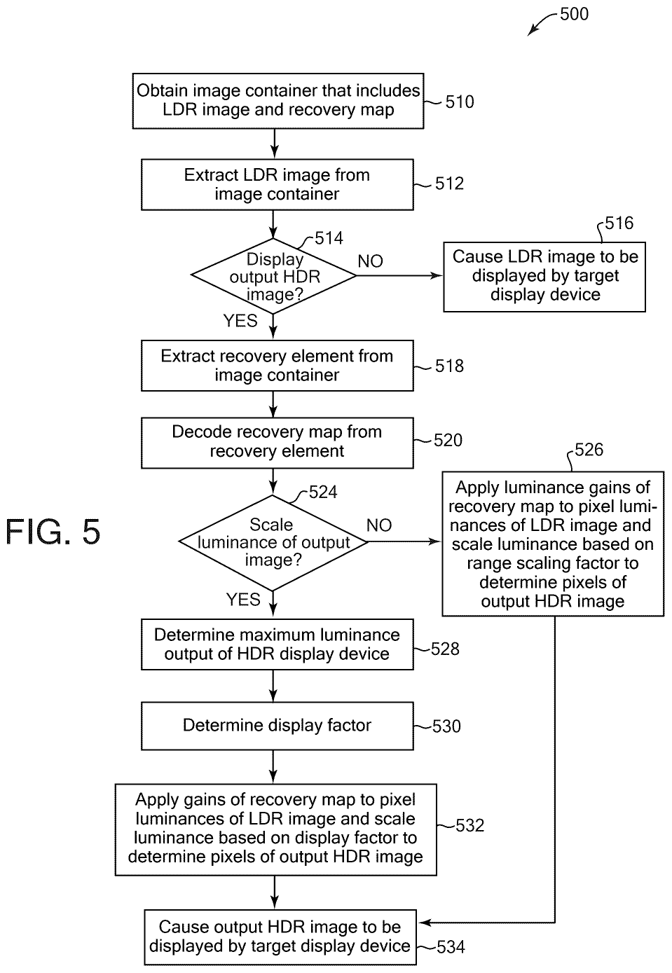

In some implementations, a respective range scaling factor can be stored in the image container to use with each of these recovery maps. In some implementations, one or more of the recovery elements can be associated with stored indications of particular display device characteristics of a target display device, as described below with respect to FIG. 5, to enable selection of one of the recovery map tracks based on a particular target display device being used for display. In some implementations, a single range scaling factor can be used with multiple recovery maps. For example, a universal range scaling factor can be used for multiple recovery maps that are respectively associated with multiple images stored in the image container.

In some implementations, additional metadata can be stored in the image container that indicates an intended usage of the recovery map. In some implementations that store multiple recovery maps in the image container, such metadata can include indications of intended usage for each of multiple recovery maps. For example, if recovery map 1 is intended for mapping to LDR images, then a map, table, or index with a key of map 1 can indicate a value that is a list of specified output formats associated with the recovery map. In some examples, the metadata can specify an indication of an output range (e.g., “LDR” or “HDR,” or HDR can be specified as a multiplier of LDR range). In some examples, the metadata can specify a bit depth, e.g., “output metadata: bit_depth X,” where X can be 8, 10, 12, etc. In some implementations, the specified bit_depth can be a minimum bit depth, e.g., “LDR” can indicate 8-bit minimum for output via opto-electronic transfer function (OETF) and 12-bit minimum for linear/extended range output; and “HDR” can indicate 10-bit minimum for output via OETF and 16-bit minimum for linear/extended range output. This type of metadata can also be used for multi-channel recovery maps, where the color space can change and the metadata can include an indication of the intended output color space. For example, the metadata can be specified as “output metadata: bit_depth X, color_space,” where color_space can be, e.g., Rec. 709, Rec. 2020, etc.

FIG. 3 is a flow diagram illustrating an example method 300 to generate a recovery map based on an HDR image and an LDR image, according to some implementations. For example, method 300 can be implemented for block 214 of method 200 of FIG. 2, or can be performed in other implementations. In some implementations, an LDR image and (original) HDR image have been obtained as described with reference to FIG. 2.

Method 300 may begin at block 302, in which a linear luminance can be determined for the LDR image. In some implementations, the original LDR image (e.g., obtained in block 212 of FIG. 2) can be a non-linear or gamma-encoded image, and a linear version of the LDR image can be generated, e.g., by transforming the primary image color space of the non-linear LDR image to a linear version. For example, a color space with a standard RGB (sRGB) transfer function is transformed to a linear color space that preserves the sRGB color primaries.

A linear luminance is determined for the linear LDR image. For example, a luminance (Y) function can be defined as:

Y_{ldr}(x,y)=primary_color_profile_to_luminance(LDR(x,y))

where Y_{ldr} is the low dynamic range image linear luminance defined on a range of 0.0 to 1.0, and primary_color_profile_to_luminance is a function that converts the primary colors of an image (the LDR image) to the linear luminance value Y for each pixel of the LDR image at coordinates (x,y). Block 302 may be followed by block 304.

In block 304, a linear luminance is determined for the HDR image. In some implementations, the original HDR image (e.g., obtained in block 210 of FIG. 2) can be a non-linear and/or three-channel encoded image (e.g., Perceptual Quantizer (PQ) encoded or hybrid-log gamma (HLG) encoded), and a three-channel linear version of the HDR image can be generated, e.g., by transforming the non-linear HDR image to a linear version. In other implementations, any other color space and color profile can be used.

A linear luminance is determined for the linear HDR image. For example, a luminance (Y) function can be defined as:

Y_{hdr}(x,y)=primary_color_profile_to_luminance(HDR(x,y))

where Y_{hdr} is the low dynamic range image linear luminance defined on a range of 0.0 to the range scaling factor, and primary_color_profile_to_luminance is a function that converts the primary colors of an image (the HDR image) to the linear luminance value Y for each pixel of the HDR image at coordinates (x,y). Block 304 may be followed by block 306.

In block 306, a pixel gain function is determined based on the linear luminances determined in blocks 302 and 304. The pixel gain function is defined as the ratio between the Y_{hdr} function and the Y_{ldr} function. For example:

$$pixel\_gain ( x , y ) = Yhdr ( x , y ) / Yldr ( x , y )$$

where Y_{hdr} is the high dynamic range image linear luminance defined on a range of 0.0 to the range scaling factor, and primary_color_profile_to_luminance is a function that converts the primary colors of an image (the HDR image) to the linear luminance value Y for each pixel of the HDR image at coordinates (x,y).

Since zero is a valid luminance value, Y_{hdr} or Y_{ldr} can be zero, leading to potential issues in the equation above or when determining a logarithm as described below. In some implementations, the case where Y_{hdr} and/or Y_{ldr} is zero can be handled by, for example, defining the pixel_gain function as 1 or by adjusting the calculation to avoid this case with the use of a sufficiently small additional factor (e.g., adding or clamping to a small factor), e.g., represented as epsilon (¿) in the equation below:

$$pixel\_gain ( x , y ) = ( Yhdr ( x , y ) + ε ) / ( Yldr ( x , y ) + ε )$$

In some implementations, different values of epsilon (¿) can be used in the numerator and denominator of the above equation. Block 306 may be followed by block 308.

In block 308, a range scaling factor is determined based on a maximum luminance of the HDR image to a maximum luminance of the LDR image. For example, the range scaling factor can be a ratio of a maximum luminance of the HDR image to a maximum luminance of the LDR image. The range scaling factor can also be referred to herein as a range compression factor, and/or a range expansion factor that is the multiplicative inverse of the range compression factor. For example, if the LDR image is determined from the HDR image, the range scaling factor can be derived from the amount that the total HDR range was compressed to produce the LDR image. For example, this factor can indicate an amount that the highlights of the HDR image are lowered in luminance to map the HDR image to the LDR dynamic range, or an amount that the shadows of the HDR image are increased in luminance to map the HDR image to the LDR dynamic range. The range scaling factor can be a linear value that may be multiplied by the total LDR range to get the total HDR range in linear space. In some examples, if the range scaling factor is 3, then the shadows of the HDR image are to be boosted 3 times, or the highlights of the HDR image are to be decreased 3 times (or a blend of such shadow boosting and highlight decreasing are to be performed). In some implementations, the range scaling factor can be defined in other ways (e.g., by a camera application or other application, a user, or other content creator) to provide a particular visual effect that may change the appearance of an output image derived from the range scaling factor. Block 308 may be followed by block 310.

In block 310, a recovery map is determined that encodes the pixel gain function scaled by the range scaling factor. The recovery map is thus, via the pixel gain function, based on the two linear images containing the desired HDR image luminance (Yhdr), and the LDR image luminance (Yldr). In some implementations, the recovery map is a scalar function that encodes the normalized pixel gain in a logarithmic space, and is scaled by the range scaling factor (e.g., multiplied by the inverse of the range scaling factor). In some examples, the recovery map values are proportional to the difference of logarithmic HDR and LDR luminances, divided by the log of the range scaling factor. For example, the recovery map can be defined as:

$$recovery ( x , y ) = log ( pixel\_gain ( x , y ) ) / log ( range\_scaling \_factor )$$

In some example implementations, recovery(x,y) can tend to be in a range of −1 to +1. Values below zero make pixels (in the LDR image) darker, for display on an HDR display device, while values above zero make the pixels brighter. In some examples of the impact of the recovery map range, to boost the highlights when displaying the image on an HDR display (examples described with reference to FIG. 5), these values can typically be in the range ˜[0 . . . 1] (e.g., applying the recovery map holds shadows steady, and boosts highlights), so that the brightest area of an image can have values close to 1, and darker areas of the image can typically have values close to 0. In some implementations, to push the shadows down (darker) when displaying on an HDR display device, these values can typically be in the range ˜[−1 . . . 0] (e.g., applying the recovery map holds highlights steady, and re-darkens the shadows). In some implementations, to provide a combination of boosting highlights and re-darkening shadows when displaying on an HDR display device, then these values can encompass the full [−1 . . . 1] range.

In some implementations as described above, the images are converted to, and processing is performed in, the logarithmic space for ease of operations. In some implementations, the processing can be performed in linear space via exponentiation and interpolating the exponents, which is mathematically equivalent. In some implementations, the processing can be performed in linear space without exponentiation, e.g., naively interpolate/extrapolate in linear space.

When applying the recovery map to the LDR image for display, the range scaling factor in general indicates an amount to increase pixels' brightness by and the map indicates that some pixels may be made brighter or darker. The recovery map indicates a relative amount to scale each pixel, and the range scaling factor indicates a specific amount of scaling to be performed. The range scaling factor provides normalization and context to the relative values in the recovery map. The range scaling factor enables making efficient use of all the bits used to store the recovery map, regardless of the amount of scaling to apply via the recovery map. This means a larger variety of images can be encoded accurately. For example, every map may contain values in the range of, e.g., −1 to 1, and the values are given context by the range scaling factor, such that this range of values can represent maps that scale to a larger total range (e.g., 2 or 8) equally well. For example, one image in the described format can have a range scaling factor of 2 and a second image can have a range scaling factor of 8. Without a range scaling factor, the maximum/minimum absolute gain values are decided in the map. If this value is, e.g., 2, then the second image with a range scale of 8 cannot be represented. If this value is, e.g., 8, then 2 bits of information are wasted for every pixel in the recovery map when storing the image with a range scale of 2. Such implementations without a range scaling factor may be more likely to have an (undesired) visual difference in the displayed output HDR image compared to the original HDR image used for encoding (e.g., a severe form of such a difference could be banding).

In some implementations, when pixel gain is 0.0, the recovery function can be defined to be −2.0, which is the largest representable attenuation. The recovery function can be outside the range −1.0 to +1.0, since one or more areas or locations in the image may require greater scaling (attenuation or gain) than represented by the range scaling factor to recover the original HDR image. The range of −2.0 to +2.0 may be sufficient to provide such greater scaling (attenuation or gain). Block 310 may be followed by block 312.

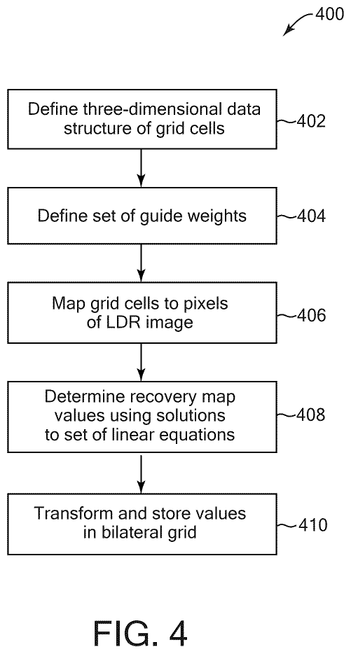

In block 312, the recovery map can be encoded into a compressed form. This allows the recovery map to occupy reduced storage space. The compressed form can be any of a variety of different compressions, formats, etc. In some implementations, the recovery map is determined and encoded into a bilateral grid, as described in greater detail with respect to FIG. 4. In some implementations, the recovery map can be compressed or otherwise reduced in storage requirements based on one or more additional or alternative compression techniques. In some implementations, the recovery map can be compressed to a lower-resolution recovery image that has a lower resolution than the recovery image determined in block 310. This recovery image can occupy less storage space than the full-resolution recovery map. For example, JPEG compression can be used in implementations that provide an LDR image in JPEG format, or other compression types can be used (e.g., Run Length Encoding (RLE)) or other image format compressions (e.g., HEIC, AVIF, PNG, etc.).

FIG. 4 is a flow diagram illustrating an example method 400 to encode a recovery map into a bilateral grid, according to some implementations. For example, method 400 can be implemented as blocks 310 and 312 of method 300 of FIG. 3, e.g., where a recovery map is determined based on luminances of an HDR image and an LDR image and is stored in compressed form, which in described implementations of FIG. 4 is a bilateral grid. The bilateral grid is a three-dimensional data structure of grid cells mapped to pixels of the LDR image based on guide weights, as described below.

Method 400 may begin at block 402, a three-dimensional data structure of grid cells is defined. The three-dimensional data structure has a width, height, and depth in a number of cells, indicated as a size W×H×D, where the width and height correspond to width and height of the LDR image and the depth corresponds to a number of layers of cells of W×H. A cell in the grid is defined as the vector element at (width, height) and of length D, and is mapped to multiple LDR image pixels. Thus, the number of cells in the grid can be much less than the number of pixels in the LDR image. In some examples, the width and height can be approximately 3% of the LDR image size and the depth can be 16. For example, a 1920×1080 LDR image can have a grid of a size on the order of 64×36×16. Block 402 may be followed by block 404.

In block 404, a set of guide weights is defined. In some implementations, the set of guide weights can be defined as a multiple-element vector of floating point values, which can be used for generating and decoding a bilateral grid. The guide weights represent the weight of the respective elements of an input pixel of the LDR image, LDR(x,y), for determining the corresponding depth D for the cell that will map to that input pixel. For example, the set of guide weights can be defined as a 5-element vector:

guide_weights={weight_r,weight_g,weight_b,weight_min,weight_max}

where weight_r, weight_g, and weight_b refers to the weight of the respective input pixel's color component (red, green, or blue), and weight_min and weight_max respectively refer to the weight of the minimum component value of the r, g, and b values, and the weight of the maximum component value of the r, g, and b values (e.g., min(r,g,b) and max(r,g,b)).

In one example, the LDR image is in the Rec. 709 color space, and the guide weights can be set to the following values, e.g., in order to represent a balance of the luminance of the LDR(x,y) pixel and that pixel's minimum and maximum component values:

guide_weights={0.1495,0.2935,0.057,0.125,0.375}

In this example, these guide weight values weight the grid depth lookup by 50% for the pixel luminance(r, g, b values), by 12.5% for the minimum component value, and by 37.5% for the pixel maximum component value. In some implementations, these values add up to 1.0, e.g., so that every grid cell can always be looked up (unlike when the values add up to less than 1.0), and the depth of a pixel can't overflow beyond the final depth level in the grid (unlike when the values add up to more than 1.0). Guide weight values can be determined, for example, heuristically by having persons visually evaluate results. In some implementations, a different number of guide weights can be used, e.g., only three guide weights for the pixel luminance(r, g, b values).

Block 404 may be followed by block 406.

In block 406, the grid cells are mapped to pixels of the LDR image based on the guide weights. The guide weights are used to determine the corresponding depth D for the cell that will map to that input pixel.

In some implementations, the width (x) and height (y) of grid cells are mapped to the pixels (x,y) of the LDR image. For example, the pixels x,y of the LDR image can be translated to the x,y coordinates of the grid cells as:

$$grid\_x = ldr\_x / ldr\_W * ( grid\_W - 1 )$$

$$grid\_y = ldr\_y / ldr\_H * ( grid\_H - 1 )$$

where grid_x and grid_y are the x and y locations of a grid cell, ldr_x and Idr_y are the x and y coordinates of a pixel of the LDR image being mapped to the grid cell, ldr_W and ldr_H are the total pixel width and height of the LDR image, and grid_W and grid_H are the total width and height cell dimensions of the bilateral grid, respectively.

In some implementations, for the depth of the grid cells mapped to the LDR image, the following equation can be used:

$$z\_idx ( x , y ) = ( D - 1 ) * ( guide\_weights \cdot \{ r , g , b , min ( r , g , b ) , max ( r , g , b ) \} )$$

where D is the total cell depth dimension of the grid and z_idx(x,y) is the depth in the bilateral grid for the cell mapped to the LDR image pixel (x,y). This equation determines the dot-product of the vector of guide weights and the vector of corresponding values for a particular pixel of the LDR image, and then scales the result by the size of the depth dimension in the grid to indicate the depth of the corresponding cell for that particular pixel. For example, the guide weight multiplication result can be a value between 0.0 and 1.0 (inclusive), and this result is scaled to the various depth levels (buckets) of the grid. For example, if D is 16, a multiplication value of 0.0 results in mapping into bucket 0, a value of 0.5 results in mapping into bucket 7, and a value of 1.0 results in mapping into bucket 15 (which is the last bucket). Block 406 may be followed by block 408.

In block 408, recovery map values are determined using solutions to a set of linear equations. For example, in some implementations the input to the bilateral grid is defined using the following equation:

pixel_gain(x,y)=bilateral_grid_linear(x,y,z_idx(x,y))

where pixel_gain(x,y) is the value at pixel (x,y) of the pixel_gain function described above with respect to method 300 of FIG. 3. Bilateral_grid_linear is the bilateral grid contents representing pixel gains in linear space. The coordinates x, y, and z_idx are the coordinates of the bilateral grid, which are different from the x,y coordinates of the LDR image. Through z_idx, the guide weights inform what depth that pixel_gain is located in the bilateral grid for each pixel of the LDR image, and this informs how to set up a linear set of equations to solve in block 410. Block 408 may be followed by block 410.

In some implementations, the encoding is defined as the solution to the set of linear equations that minimizes the following equation for each grid cell:

$${( pixel\_gain ( x , y ) = Yldr ( x , y ) / Yhdr ( x , y ) )}^{2}$$

The Y_{ldr} and Y_{hdr} values are luminance values of the LDR image and the HDR image, respectively, at the (x,y) pixel position of the LDR image. The pixel_gain(x,y) values that minimize the value of the above equation are solved for based on where each pixel is looked up into the depth vectors as indicated in the previous equation above; this is predetermined based on the guide weights.

The resulting values are defined as the following:

For {x,y,z} over {[0,W),[0,H),[0,D)}: bilateral_grid_linear(x,y,z)

This definition specifies that the bilateral grid is defined for x from 0 to the total grid width, for y from 0 to the total grid height, and for z from 0 to the total grid depth. For example, if the bilateral grid is 64×36×16, then grid values are defined for x over 0 to 63 inclusive, for y over 0 to 35 inclusive, and for z over 0 to 15 inclusive. Block 408 may be followed by block 410.

In block 410, the solved values are transformed and stored in the bilateral grid. For example, the solved values can be transformed as:

$$bilateral\_grid ( x , y , z ) = log ( pixel\_gain ( x , y ) ) / log ( range\_scaling \_factor )$$

$$or$$

$$bilateral\_grid ( x , y , z ) = log ( bilateral\_grid \_linear ) / log ( range\_scaling \_factor )$$

Bilateral_grid is the bilateral grid contents representing pixel gains in log space. These values are stored as an encoded recovery map. As indicated in these equations, the normalized pixel gain between the LDR image and the HDR image is encoded in a logarithmic space and scaled by the range scaling factor, similarly as described above with respect to block 310 of FIG. 3.

When decoding the recovery map from the bilateral grid for display of an HDR image having greater dynamic range than the LDR image(as described in greater detail with respect to FIG. 5), each recovery map value is extracted from the bilateral grid. In the below equations, r, g, and b are the respective component values for a pixel LDR(x,y) of the LDR image.

$$z\_idx ( x , y ) = ( D - 1 ) * ( guide\_weights \cdot \{ r , g , b , min ( r , g , b ) , max ( r , g , b ) \} )$$

$$recovery ( x , y ) = bilateral\_grid ( x , y , z\_idx ( x , y ) )$$

where recovery(x,y) is the extracted recovery map. In some implementations, z_idx, as determined in the first equation, can be rounded to the nearest whole number before being input to bilateral_grid(x,y,z) in the second equation.

FIG. 5 is a flow diagram illustrating an example method 500 to decode and display an image of a backward-compatible high dynamic range image format, according to some implementations. In some implementations, method 500 can be performed, for example, on a server system 102 as shown in FIG. 1. In some implementations, some or all of the method 500 can be implemented on one or more client devices such as client devices 120, 122, 124, or 126 of FIG. 1, one or more server devices such as server device 104 of FIG. 1, and/or on both server device(s) and client device(s). In described examples, the implementing system includes one or more digital processors or processing circuitry (“processors”), and one or more storage devices (e.g., a database or other storage). In some implementations, different components of one or more servers and/or clients can perform different blocks or other parts of the method 500. In some examples, a device is described as performing blocks of method 500. Some implementations can have one or more blocks of method 500 performed by one or more other devices (e.g., other client devices or server devices) that can send results or data to the first device.

In some implementations, the method 500, or portions of the method, can be initiated automatically by a system. For example, the method (or portions thereof) can be performed periodically, or can be performed based on one or more particular events or conditions, e.g., a client device launching image application 106, capture or reception of new images by a client device, upload of new images to a server system 102, a predetermined time period having expired since the last performance of method 500, and/or one or more other conditions occurring which can be specified in settings read or received by the system performing the method.

Method 500 can be performed by a different device than the device that created the image container. For example, a first device can create the image container and store it in a storage location (e.g., a server device) that is accessible by a second device that is different than the first device. The second device can access the image container to display an image therefrom according to method 500. In some examples, the application of recovery map to base image can be performed by a hardware decoder, and/or by a CPU and/or GPU of the second device. In some implementations, a single device can create the image container as described in method 200 and can decode and display the image container as described in method 500. In some implementations, a first device can decode an image from the image container based on method 500, and can provide the decoded image to a second device to display the image.

Similarly as described above with reference to FIG. 2, in some implementations, a first device (e.g., a server device in the cloud) can decode two images from the image container (e.g., a base image and a derived image based on the base image and recovery map) and send the two images to a second device to select and display one of the images as determined by the second device, e.g., based on the display device characteristics of the second device.

User permissions can be obtained to use user data in method 500 (blocks 510-534). For example, user data for which permission is obtained can include images stored on a client device (e.g., any of client devices 120-126) and/or a server device, image metadata, user data related to the use of an image application, other image-based creations, etc. The user is provided with options to selectively provide permission to access all, any subset, or none of user data. If user permission is insufficient for particular user data, method 500 can be performed without use of that of user data, e.g., using other data (e.g., images not having an association with the user).

Method 500 may begin at block 502. In block 510, an image container is obtained that includes an LDR image and a recovery map. For example, the image container can be a container created by method 200 of FIG. 2, that generates a recovery map from an HDR image and an LDR image, where the HDR image has a greater dynamic range than the LDR image. The recovery map can be provided in the container as a recovery element, such as a recovery image. The image container can have a standardized format that is supported and recognized by the device performing method 500, e.g., a container for JPEG, custom JPEG markers (e.g., APP1 segment to store metadata in a JPEG/Exif file, or markers to store chunks of data), International Organization for Standardization Base Media File Format (ISOBMFF), a container for AV1 Image File Format (AVIF), HEIF (High Efficiency Image File), Multi-Picture Format (MPF) container, Extensible Metadata Platform (XMP) encoded data, etc. In some implementations, the recovery map can be stored as a secondary image according to a standard (e.g., AVIF, HEIF), or the recovery map can be stored as a new type of auxiliary image (e.g., define an AV1 Gain Map Image Item that signals to the reading device that the image item is a gain map and used accordingly; and, e.g., defining the range scaling factor in a header). Block 510 may be followed by block 512.

In block 512, the LDR image in the image container is extracted. In some example implementations, this extraction can include decoding the LDR image from its standard file format (e.g., JPEG) to a raw image format or other format for use in display and/or processing. The decoded values from the encoded map can be determined in the equation below, where r is the range and n is the number of bits in each recovery map value:

$$recovery ( x , y ) = ( encode ( x , y ) - ( 2 \hat{} n - 1 ) / 2 ) / ( ( 2 \hat{} n - 1 ) / 2 r )$$

In some example implementations, in relation to the example of the quantized encoded map (encode(x,y)) described above for block 218 of FIG. 2, the decoded values from the encoded map can be determined as:

$$recovery ( x , y ) = ( enco de ( x , y ) - 127.5 ) / 63.75$$

Which provides a scale and offset for a range of recovery map values of −2 to 2 and storing as 8 bits. In another example, if the values stored in the recovery map are −1 to 1, the decoded values can be determined as:

$$recovery ( x , y ) = ( enco de ( x , y ) - 127.5 ) / 127.5$$

Other ranges, scales, offsets, number of bits of storage, etc. can be used in other implementations. Block 512 may be followed by block 514.

In block 514, it is determined whether to display an output image that is an HDR image derived from the extracted LDR image (e.g., a derived image), or to display an output image that is the LDR image. The output image is to be displayed on at least one target display device associated with or in communication with the device that is performing method 500 and accessing the image container. The target display device can be any suitable output display device, e.g., display screen, touchscreen, projector, display goggles or glasses, etc. An output HDR image to be displayed can have any dynamic range above the LDR image in the container, up to a dynamic range of the original HDR image used in creating the image container (e.g., in block 210 of FIG. 2).

The determination of whether to display an output HDR image can be based on one or more characteristics of the target display device that is to display the output image. For example, the dynamic range of the target display device can determine whether to display an HDR image or the LDR image as the output image. In some examples, if the target display device is capable of displaying a greater dynamic range than the dynamic range of the LDR image in the image container, then it is determined to display an HDR image. If the target display device is capable only of displaying the low dynamic range of the LDR image in the container, then an HDR image is not to be displayed.

In some implementations or cases, it is determined to not display an HDR image even though the target display device is capable of greater dynamic range than the LDR image. For example, user settings or preferences may indicate to display an image having a lower dynamic range, or the displayed image is to be displayed as an LDR image to be visually compared to other LDR images, etc.

If an HDR image is determined to not be displayed in block 514, then the method proceeds to block 516, in which the LDR image extracted from the image container is caused to be displayed by the target display device. Typically, the LDR image is displayed by an LDR-compatible target output device that is not capable of displaying a greater dynamic range than the range of the LDR image. The LDR image can be output directly by the target display device, and the recovery map and any metadata pertaining to the HDR image format in the image container is ignored. In some implementations, the LDR image is provided in a standard format, and thus it is readable and displayable by any device that can read the standard format.

If an HDR image is determined in block 514 to be displayed as the output image, then the method proceeds to block 518, in which the recovery element in the image container is extracted. Metadata related to display of an output HDR image based on the recovery element can also be obtained from the image container. For example, the recovery element can be a recovery image as described above, and this recovery image can include and/or be accompanied by metadata as described above. Metadata can also or alternatively be included in the container and/or in the LDR image from the image container.

In some implementations, multiple recovery maps (e.g., recovery elements) can be included in the image container as described above. In some of these implementations, one of the multiple recovery elements can be selected in block 518 for processing below. In some implementations, the recovery element that is selected can be specified by user input or user settings, or in some implementations can be automatically selected (e.g., without current user input) by a device performing the processing, e.g., based on one or more characteristics of a target output display device or other output display component, where such characteristics can be obtained using via an operating system call or other available source. For example, in some implementations, one or more of the recovery elements can be associated with indications of particular display device characteristics that are stored in the image container (or are otherwise accessible to the device performing block 518). If the target display device is determined to have one or more particular characteristics (e.g., dynamic range, peak brightness, color gamut, etc.) the particular recovery element that is associated with those characteristics can be selected in block 518. If the multiple recovery elements are associated with different range scaling factors, the associated range scaling factor is also selected and retrieved. Block 518 may be followed by block 520.

In block 520, the recovery map is optionally decoded from the recovery element. For example, the recovery map may be in a compressed or other encoded form in the recovery element, and can be uncompressed or decoded. For example, in some implementations the recovery map can be encoded in a bilateral grid as described above, and the recovery map is decoded from the bilateral grid. Block 520 may be followed by block 522.

In block 524, it is determined whether to scale the luminance of the extracted LDR image for the output HDR image. In some implementations, this scaling is based on the display output capability of the target display device. For example, in some implementations or cases, the generation of the output HDR image is based in part on a particular luminance that the target display device is capable of displaying. In some implementations or cases, this particular luminance can be the maximum luminance that the target display device is capable of displaying, such that the display device maximum luminance caps the luminance of the output HDR image. In some implementations or cases, in block 524 it is determined not to scale the luminance of the LDR image, e.g., the generation of the output HDR image does not take the luminance capability of the target display device into account.

If it is determined to not scale the luminance of the output image based on target display device capability in block 524, then the method proceeds to block 526, in which the luminance gains of the recovery map are applied to the pixels of the LDR image and the pixels are scaled based on the range scaling factor to determine corresponding pixels of the output HDR image. For example, the luminance gains and scaling are applied to luminances of pixels of the LDR image to determine respective corresponding pixel values of the output HDR image that is to be displayed. This causes the output HDR image to have the same dynamic range as the original HDR image used to create the image container.

In some example implementations, the LDR image and range scaling factor are converted to a logarithmic space, and the following equation can be used:

$$HDR * ( x , y ) = LDR * ( x , y ) + log ( range\_scaling \_factor ) * recovery ( x , y )$$

where HDR*(x,y) is pixel (x,y) of the recovered HDR image(output image) in the logarithmic space; LDR*(x,y) is the pixel (x,y) of the logarithmic space version of the extracted LDR image (e.g., log(LDR(x,y)); log(range_scaling_factor) is the range scaling factor in the logarithmic space; and recovery(x,y) is the recovery map value at pixel (x,y). For example, recovery(x,y) is the normalized pixel gain in the logarithmic space.

In some examples, interpolation is provided between the LDR and HDR versions of the image when the per-pixel gain is applied, e.g., recovery(x,y)*range scaling factor. This is essentially interpolating between the original version and the range-compressed version of an image, and the interpolation amount is dynamic, both in the sense of being pixel by pixel, and also globally, because it is dependent on the range scaling factor. In some examples, this can be considered extrapolation if the recovery map value is less than 0 or greater than 1.

In some implementations, the LDR image from the image container is nonlinearly encoded, e.g., gamma encoded, and the primary image color space of the non-linear LDR image is converted to a linear version before the LDR image is converted to LDR*(x,y) in the logarithmic space for the equation above. For example, a color space with a standard RGB (sRGB) transfer function can be transformed to a linear color space that preserves the sRGB color primaries, similarly as described above for block 302 of FIG. 3. In some implementations, the LDR image in the container can be linearly encoded, and such a transformation from a non-linear color space is not used.

Applying the luminance gains to luminances of individual pixels of the LDR image results in pixels corresponding to the original (e.g., originally-encoded) HDR image. If lossless storage of the LDR image and the recovery map is provided, the output HDR image can have the same pixel values as the original HDR image (e.g., if the recovery map has the same resolution as the LDR image). Otherwise, the output HDR image resulting from block 532 can be a very close approximation to the original HDR image, where the differences are usually not visually noticeable to users in a display of the output image.

In some implementations, the output image can be transformed from the logarithmic space to the output color space for display. In some implementations, e.g., if using a multi-channel recovery map, the output image color space can be different from the color space of the LDR image extracted from the image container. Block 526 may be followed by block 534, described below.

If it is determined to scale the luminance of the image based on target display device output in block 524, then the method proceeds to block 528, in which the maximum luminance output of the target display device is determined. The target display device can be an HDR display device, and these types of devices are capable of displaying maximum luminance values that may vary based on model, manufacturer, etc. of the display device. In some implementations, the maximum luminance output of the target display device can be obtained via an operating system call or other source. Block 528 may be followed by block 530, described below.

In block 530, a display factor is determined. The display factor is used to scale the dynamic range of the output HDR image that is to be displayed, as described below. In some implementations, the display factor is determined to be equal to or less than the minimum of the luminance output of the target display device and the range scaling factor. For example, this can be stated as:

display factor≤min(maximum display luminance,range scaling factor)

This determination allows the luminance scaling of the output image to be capped at the maximum display luminance of the target display device. This prevents scaling the output image to a luminance range that is present in the original HDR image from which the image container was created (as indicated in the range scaling factor), but which is greater than the maximum luminance output range of the target display device. In some implementations, the maximum display luminance may be a dynamic characteristic of the target display device, e.g., may be adjustable by user settings, application program, etc.

In some implementations, the display factor can be set to a luminance that is greater than the range scaling factor and is less than or equal to the maximum display luminance. For example, this can be performed if the target display device can output a greater dynamic range than the dynamic range present in the original HDR image(which can be indicated in the range scaling factor). In some examples, a user (through user settings or selection input) may indicate that the output image be brightened.

In some implementations, the display factor can be set to a luminance that is below the maximum display luminance of the target display device and the maximum luminance of the original HDR image. For example, the display factor can be set based on a particular display luminance of the display device indicated by one or more display conditions, by user input, user preferences or settings, etc., e.g., to cause output of a lower luminance level that may be desired in some cases or applications as described below. Block 530 may be followed by block 532, described below.

In block 532, the luminance gains of the recovery map are applied to the LDR image and the luminance of the LDR image is scaled based on the display factor to determine corresponding pixels of the HDR image. For example, the luminance gains encoded in the recovery map are applied to pixel luminances of the LDR image to determine respective corresponding pixel values of the output image that is to be displayed. These pixel values are scaled based on the display factor determined in block 530, e.g., based on a particular luminance output of the target display device (which can be the maximum luminance output of the target display device). In some implementations, this allows the highlight luminances in the LDR image to be increased to a level that the display device is capable of displaying, up to a maximum level based on the dynamic range of the original HDR image; or allows the shadow luminances in the LDR image to be decreased to a level that the display device is capable of displaying, down to a lower limit based on the dynamic range of the original HDR image.

In some example implementations, the LDR image and display factor are converted to a logarithmic space, and the following equation can be used:

$$HDR * ( x , y ) = LDR * ( x , y ) + log ( display\_factor ) * recovery ( x , y )$$

where HDR*(x,y) is pixel (x,y) of the recovered HDR image(output image) in the logarithmic space; LDR*(x,y) is the pixel (x,y) of the logarithmic space version of the extracted LDR image (e.g., log(LDR(x,y)); log(display_factor) is the display factor in the logarithmic space; and recovery(x,y) is the recovery map value at pixel (x,y). For example, recovery(x,y) is the normalized pixel gain in the logarithmic space.

In some examples, interpolation can be considered to be provided between the LDR and HDR versions of the image when the per-pixel gain is applied, e.g., recovery_map(x,y)*display factor. This can be considered essentially interpolating between the original version and the range-compressed version of an image, and the interpolation amount is dynamic, both in the sense of being pixel by pixel, and also globally, because it is dependent on the display factor. In some examples, this can be considered extrapolation if the recovery map value is less than 0 or greater than 1.

In some implementations, the LDR image from the image container is nonlinearly encoded, e.g., gamma encoded, and the primary image color space of the non-linear LDR image is converted to a linear version before the LDR image is converted to LDR*(x,y) in the logarithmic space for the equation above. For example, a color space with a standard RGB (sRGB) transfer function can be transformed to a linear color space that preserves the sRGB color primaries, similarly as described above for block 302 of FIG. 3. In some implementations, the LDR image in the container can be linearly encoded, and such a transformation from a non-linear color space is not used.

Applying the luminance gains to luminances of individual pixels of the LDR image results in pixels corresponding to the original (e.g., originally-encoded) HDR image. If lossless storage of the LDR image and the recovery map is provided, the output HDR image can have the same pixel values as the original HDR image (e.g., if the recovery map has the same resolution as the LDR image). Otherwise, the output HDR image resulting from block 532 can be a very close approximation to the original HDR image, where the differences are usually not visually noticeable to users in a display of the output image.

In some implementations, the output image can be transformed from the logarithmic space to the output color space for display. In some implementations, e.g., if using a multi-channel recovery map, the output image color space can be different from the color space of the LDR image extracted from the image container. Block 532 may be followed by block 534.

In block 534, the output HDR image determined in block 526 or in block 532 is caused to be displayed by the target display device. The output HDR image is displayed by an HDR-compatible display device that is capable of displaying a greater dynamic range than the range of the LDR image. The output HDR image generated from the image container can be the same as the original HDR image that was used to create the image container, due to the recovery map storing the luminance information, or may be approximately the same and typically indistinguishable visually from the original HDR image.

In some implementations, the output HDR image(from block 526 or block 532) may be suitable for display by the target display device, e.g., as a linear image or other output HDR image format. For example, the output HDR image may have been processed via the display factor of block 532, and may not need to be modified further for display, such that the output HDR image resulting from application of the recovery map is directly rendered for display.

In some implementations or cases, the output HDR image can be converted to a different format for display by the target display device, e.g., to an image format that may be more suitable for display by the target display device than the output HDR image. For example, the output HDR image from block 526 (or from block 532 in some implementations) can be converted to luminance range that is suited to the capabilities of the target display (which, in some implementations, can be in addition to the use of a display factor as in block 532). In some implementations, the output HDR image can be converted to a standard image having a standard image format, e.g., HLG/PQ or other standard HDR format. In some of these examples, a generic tone mapping technique can be applied to such a standard image for display by the target display device.

In some implementations or cases, an output HDR image that has been processed for the target display device via the display factor of block 532, without being further converted to a standard format and processed for display using a generic tone mapping technique, may provide a higher quality image display on the target device than an output HDR image that is so converted and processed via a generic tone mapping technique. For example, local tone mapping provided via the recovery map can provide higher quality images than generic or global tone mapping, e.g., greater detail. Furthermore, there may be ambiguity and differences in conversion from HDR images to some standard formats using a global tone mapping technique, based on different device specifications and implementations.

In some implementations, a technique can be used to output the image to the display device in a linear format, e.g., an extended range format where 0 represents black, 1 represents SDR white, and values above 1 represent HDR brightnesses. Such a technique can avoid issues with global tone mapping techniques to handle display capabilities of the target display device. One or more techniques described herein can handle display device display capabilities via application of the recovery map via a display factor as described above, so that extended range values do not exceed display capabilities of the display device.

As described above, a device can scale the pixel luminances of an LDR image based on a maximum luminance output of an HDR display device and based on the luminance gains stored in the recovery map. In some implementations, e.g., in many photography and videography uses, the scaling of the LDR image can be used to produce an HDR output image that reproduces the full dynamic range of the original HDR image used to create the image container (if the target display device is capable of displaying that full range). In some implementations, the scaling of the LDR image can set, for the output HDR image, an arbitrary dynamic range above the range of the LDR image. In some implementations, the dynamic range can also be below the range of the original HDR image. For example, the output image luminances can be scaled based on the capability of the target display device and/or other criteria, or can be scaled lower than the original HDR image and/or lower than the maximum capability of the target display device so as to reduce the displayed brightness in the image that, e.g., may be visually uncomfortable or fatiguing for viewers. For example, a fatigue-reducing algorithm and one or more light sensors in communication with a device implementing the algorithm can be used to detect one or more of various factors such as ambient light around the display device, time of day, etc. to determine a reduced dynamic range or reduced maximum luminance for the output image. For example, the reduced luminance level of the output image can be obtained by scaling the recovery map values and/or display factor that are used in determining an HDR image as described for some implementations herein, e.g., scale the range_scaling_factor and/or display factor in the example equations indicated above. In another example, a device may determine that its battery power level is below a threshold level and that battery power is to be conserved (e.g., by avoiding high display brightness), in which case the device causes display of HDR images at less than the brightness of the original HDR image.

In some implementations, the luminances of the LDR image can be scaled greater (e.g., higher) than the dynamic range of the original HDR image, e.g., if the target display device has a greater dynamic range than the original HDR image. The dynamic range of the output HDR image is not constrained to the dynamic range of the original HDR image, nor to any particular high dynamic range. In some examples, the maximum of the dynamic range of the output HDR image can be lower than the maximum dynamic range of the original HDR image and/or lower than the maximum dynamic range of the target output device.

In some implementations, display of the output HDR image can be gradually scaled from a lower luminance level to the full (maximum) luminance level of the output HDR image (the maximum luminance level determined as described above). For example, the gradual scaling can be performed over a particular period of time, such as 2-4 seconds (which can be user configurable in some implementations). Gradual scaling can avoid user discomfort that may result from a large and sudden increase of brightness when displaying a higher-luminance HDR image after displaying a lower luminance(e.g., display of an LDR image). Gradual scaling from the LDR image to the HDR version of that image can be performed, for example, by scaling the recovery map values and/or display factor used in determining an HDR image as described herein, e.g., in multiple steps to gradually brighten the LDR image to the HDR version of the image. For example, the range_scaling_factor and/or display_factor can be scaled in the equations indicated above. In other implementations, multiple scaling operations can be performed in succession to obtain intermediate images of progressively higher dynamic range over the period of time. Other HDR image formats that scale LDR images to HDR images using global tonemapping techniques as described above instead of local tonemapping as described for the HDR format herein may have poorer display quality when performing such gradual scaling or may not support gradual scaling.

In some examples, this gradual scaling of HDR image luminance can be performed or triggered for particular display conditions. Such conditions can include, for example, when the output HDR image is displayed immediately after display of an LDR image by the display device. In some examples, a grid of LDR images can be displayed, and the user selects one of these images to fill the screen with a display of the HDR version of the selected image(where the HDR image can be determined based on the recovery element from an associated image container as described above). To avoid a large sudden increase of brightness when changing from LDR image display to HDR image display, the HDR image can be initially displayed at the lower luminance level of the LDR image and gradually updated (e.g., by progressively displaying the image content with higher dynamic range, increasing in increments up to its maximum luminance level; e.g., fade-in and fade-out animations. In another example, the display conditions to trigger gradual scaling can include an overall screen brightness that is set at a low level as described herein (e.g., based on an ambient low light level around the device). For example, the overall screen brightness can have a luminance level below a particular threshold level to trigger the gradual scaling of HDR luminance.

In some cases or conditions, an output HDR image can be immediately displayed at its maximum luminance without the gradual scaling, e.g., when one or more HDR images are being displayed and are to be replaced by the output HDR image. For example, when a second HDR image is displayed following the display of a first HDR image, the second HDR image can be immediately displayed at its maximum luminance since the user is already accustomed to viewing the increased luminance of the first HDR image.

In some implementations, after display of the output image (e.g., either the LDR or HDR output image), the device that provides the display of the output image can receive user input from a user (or other source, e.g., other device) that instructs to modify the display of the output image, e.g., to increase or reduce the dynamic range of the display, up to the maximum dynamic range of the display device and/or the original HDR image. For example, in response to receiving user input that modifies the display, the device can modify the display factor (described above) in accordance with the user input, which changes the dynamic range of the displayed output image. In some examples, if the user decreases the dynamic range, the display factor can be reduced by a corresponding amount and the output image displayed with a resulting lower dynamic range. This change of display can be provided in a real-time manner in response to user input.

In some implementations, after display of the output image, the device providing the display of the output image can receive input that instructs to modify or edit the output image, e.g., input from a user or other source, e.g., other device. In some implementations, the recovery map can be discarded after such modification, e.g., it may no longer properly apply to the LDR image. In some implementations, the recovery map can be preserved after such modification. In some implementations, the recovery map can be updated based on the modification to the output image to reflect the modified version of the LDR image.

In some examples, if the modification is performed by a user on an HDR display and/or via an HDR-aware editing application program, then characteristics of the modification are known in the greater dynamic range and the recovery map can be determined based on the edited image. For example, in some implementations, at load time of the image to an image editing interface, the recovery map can be decoded to a full-resolution image and presented in the editor as an alpha channel, other channel, or data associated with the output image. For example, the recovery map can be displayed in the editor as an extra channel in a list of channels for the image. The LDR image and the HDR output image can both be displayed in the editor, to provide visualization of modifications to the image in both versions. When edits to the image are made by the user using tools of the editor, corresponding edits are made to the recovery map and to the LDR image (base image). In some examples, the user can decide whether to edit RGB, or RGBA (red green blue alpha), for the image. In some implementations, the user can edit the recovery map (e.g., alpha channel) manually, and view the displayed HDR image change while the displayed LDR image stays the same.

In some implementations, an overall dynamic range control can be provided in the image editing interface, which can adjust the range scaling factor higher or lower. Edit operations to images such as cropping, resampling, etc. can cause the alpha channel to be updated in the same way as the RGB channels. At the time of saving the image, an LDR image can be saved back into the image container. The saved LDR image may have been edited in the interface, or may be a new LDR image generated via local tone mapping from an edited HDR image or generated based on the edited HDR image scaled by (e.g., divided by) the recovery map at each pixel. An edited recovery map can be saved back into the image container. In various implementations, the recovery map can be processed back into a bilateral grid, if such encoding is used; or the image and recovery map can be saved losslessly, with greater storage requirements, e.g., if additional editing to the image is to be performed.

In some implementations, an editor or any other program can convert an LDR image and recovery map of the described image format into a standard HDR image, e.g., a 10-bit HDR AVIF image or an image of a different HDR format.

In various implementations, various blocks of methods 200, 300, 400, and/or 500 may be combined, split into multiple blocks, performed in parallel, or performed asynchronously. In some implementations, one or more blocks of these methods may not be performed or may be performed in a different order than shown in these figures. For example, in various implementations, blocks 210 and 212 of FIG. 2, and/or blocks 302 and 304 of FIG. 3, can be performed in different orders or in parallel. Methods 200, 300, 400, and/or 500, or portions thereof, may be repeated any number of times using additional inputs. For example, in some implementations, method 200 may be performed when one or more new images are received by a device performing the method and/or are stored in a user's image library.

In some implementations, the HDR image and LDR image can be reversed in their respective roles described above. For example, an original HDR image can be stored in the image container (e.g., as the base image, in block 218) instead of an original LDR image that has lower dynamic range than the HDR image. A recovery map can be determined and stored in the image container that indicates how to determine a derived output LDR image from the base HDR image for an LDR display device that can only display a lower dynamic range that is lower than the dynamic range of the HDR image. The recovery map can include gains and/or scaling factor that are based on the base HDR image and original LDR image, where the original LDR image, in some implementations, can be a tone-mapped image(or otherwise range conversion of the HDR image), similarly as described above.

Some of the described implementations can enable applications that provide HDR images to obtain and output higher quality LDR images based on tone mappings of the HDR images, without the limitations of current techniques (e.g., HLG/PQ transfer functions) that provide global or generic tone mapping for an entire image. The local tone mapping provided by use of the recovery map techniques as described herein, without applying global or generic tone mapping, can enable higher fidelity conversions to LDR images from HDR images, e.g., for uses such as sharing images, or uploading images to services or applications that only support LDR images.

In some implementations, a luminance control can be provided for display of HDR images such as the HDR images described herein. The HDR luminance control can be adjusted by the user of the device to designate a maximum luminance(e.g., brightness) at which HDR images are displayed by the display device. In some implementations, the maximum luminance of the HDR image can be determined as a maximum of the average luminance of the displayed pixels of the HDR image, since such an average may be indicative of perceived image brightness to users. In other implementations, the maximum luminance can be determined as a maximum of the brightest pixel of the HDR image, as a maximum of one or more particular pixels of the HDR image(or a maximum of an average of such particular pixels), and/or based on one or more other characteristics of the HDR image. If the luminance control is set to a value below the maximum displayable luminance of HDR images, the device reduces the maximum luminance of the output HDR image to a lower luminance level that is based on the luminance control. This allows the user to adjust the maximum luminance of displayed HDR images if the user prefers a lower maximum luminance level, e.g., to avoid discomfort or fatigue from glare of high luminance HDR images, and/or to reduce contrast between a high luminance HDR image and other contents of a display screen outside of the HDR image(which may be being displayed at lower luminance, e.g. LDR images, user interface elements, etc.). In some cases, a reduced maximum luminance level for HDR images can reduce the expenditure of battery power by the device providing the display due to the lower brightness of the display.

For example, the HDR luminance control can be implemented as a global or system luminance control provided by the device (e.g., provided by an operating system executing on the device) that controls HDR image luminance for applications that execute on the device and which display HDR images. In some examples, the luminance control can be applied to all such applications that execute on the device, all applications of a particular type that execute on the device (e.g., image viewing and image editing applications), and/or particular applications designated by the user. This allows the user, for example, to designate a single luminance adjustment for all (or many) HDR images displayed by a device, without having to adjust luminance for each individual displayed HDR image. Such a system luminance control can provide consistency of display by all applications that execute on the device and also can provide more control to the user as to the maximum luminance of displayed HDR images. In some implementations, the HDR luminance control can be implemented with other system controls on a device, e.g., as accessibility controls, user preferences, user settings, etc. The value set by the system luminance control can be used to adjust the output of an HDR image output in addition to any other scaling factors being used to display that image, e.g., the display factor based on the maximum display device luminance as described above, individual luminance settings for an image, etc.

In some examples, the system luminance control can be implemented as a slider or a value that can be adjusted by the user, e.g., to indicate a maximum luminance value or a percentage of maximum displayable luminance for HDR images by the display device (e.g., where the maximum luminance can be determined as the maximum of average luminance of the pixels of the HDR image, the maximum of the brightest pixel or particular pixels of the HDR image, or a maximum based on one or more other image characteristics). For example, if the luminance control is set to 70% by the user, HDR images can be displayed at 70% of their maximum luminance(e.g., 70% of the maximum luminance of the display device if that is used to determine maximum luminance as described above). In some implementations, the system luminance control can allow a user to designate different maximum HDR image luminances for different screen luminances. For example, if the entire screen is displaying content at a higher screen luminance, the maximum HDR image luminance can be higher, e.g., 90% or 100%, since there is not much contrast between the overall screen luminance and the HDR image luminance. At low screen luminance, the maximum HDR image luminance can be lower, e.g., 50% or 60%, to reduce the contrast between the overall screen luminance and HDR image luminance. In some implementations, the system luminance control can be provided as a setting (e.g., via a slider or other interface control) that is relative to the maximum SDR image luminance. For example, the setting could set the maximum HDR luminance value to a value that is N times the maximum SDR image luminance, where N has a maximum settable value that is based on the maximum luminance of the display device used to display the images. In some examples, a setting value of 1 can indicate a maximum luminance of the SDR (base) image, and a setting value that is a maximum value or setting of the luminance control indicates to display at the maximum luminance of the display device.

In some implementations, these variable settings for HDR image luminance can be input via user interface controls. For example, the user can define a curve that has a variable maximum HDR luminance vs. current screen luminance. In some implementations, multiple predetermined HDR luminance configurations can be provided in a user interface, and the user can select one of these configurations for use on the device. For example, each configuration can provide a different set of maximum HDR luminance values associated with particular ranges of screen luminance values. In some implementations, a toggle control can be provided that, if selected by the user, removes the HDR luminance such that HDR images are displayed at LDR luminance. For example, if the toggle is selected by the user, an associated recovery map or recovery element (as described herein) can be ignored and the base image is displayed.

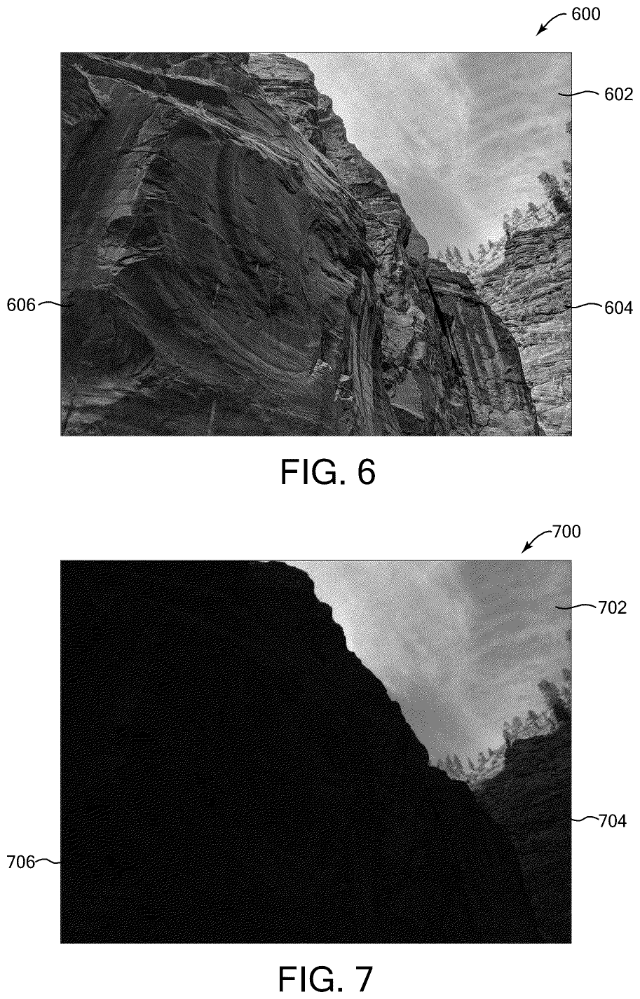

FIG. 6 is an illustration of an example approximation of an image 600 that has a high dynamic range (the full dynamic range of the HDR image is not presentable in this representation; e.g., it is an LDR depiction of an HDR scene). For example, HDR image 600 may have been captured by a camera that is capable of capturing HDR images. In image 600, the image regions 602, 604, and 606 are shown in detail and the greater dynamic range enables these regions to be portrayed as they naturally appear to the human observer.

FIG. 7 shows an example of a representation of an LDR image 700 that has a lower dynamic range than the HDR image 600, such as the low dynamic range of a standard JPEG image. LDR image 700 depicts the same scene as in images 600 and 700. For example, image 700 may be an LDR image captured by a camera. In this example, the sky image region 702 is exposed properly, but the foreground image regions 704 and 706 are shadows that are not fully exposed due to lack of range compression in the image, thus causing these regions to be too dark and to lose visual detail.

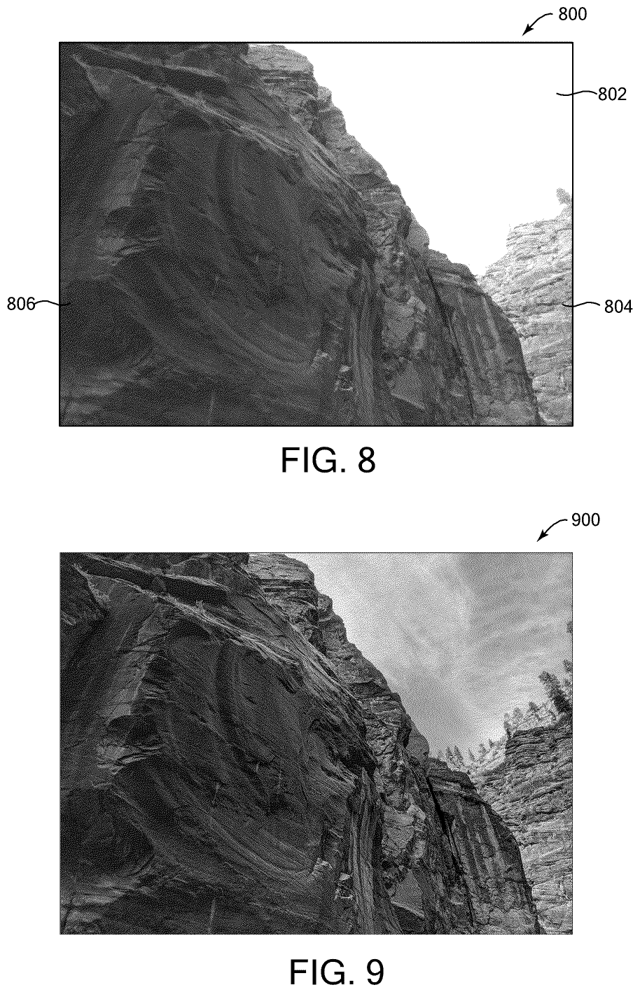

FIG. 8 is another example of an image 800 that has a lower dynamic range than the HDR image 600 similarly to LDR image 700, and depicts the same scene as in images 600 and 700. For example, image 800 may be an LDR image captured by a camera. In this example, due to lack of range compression in the image, the sky image region 802 is overexposed and thus its detail is washed out, while the foreground image regions 804 and 806 are exposed properly and include appropriate detail.

FIG. 9 is an example of a range-compressed LDR image 900. For example, image 900 can be locally tone mapped from HDR image 600. The local tone mapping can be performed using any of a variety of tone mapping techniques. For example, the shadows of image 700 can be increased in luminance while preserving the contrast of the edges in the image. Thus, while image 900 has a lower dynamic range than image 600 (which is not perceivable in these figures), it can preserve the detail over more of the image than the image 700 of FIG. 7 and image 800 of FIG. 8. A range-compressed image such as image 900 can be used as the LDR image in the image format described herein, and can be included in the described image container as an LDR version of a provided HDR image.

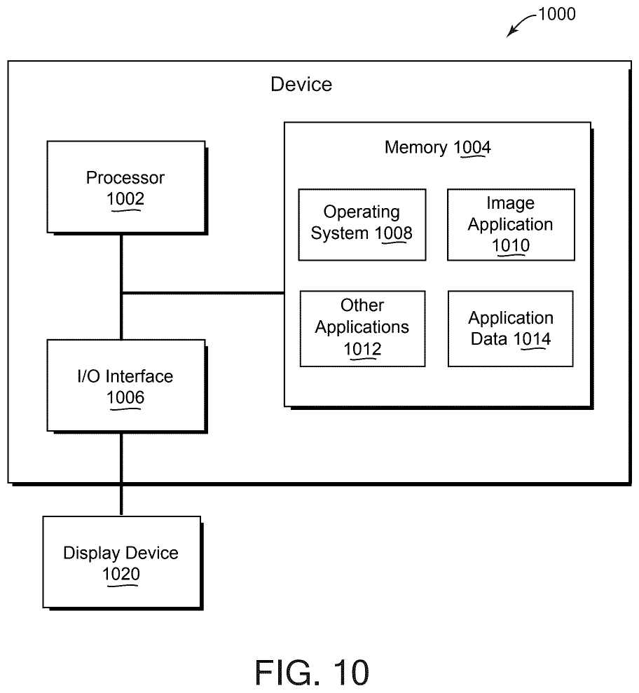

FIG. 10 is a block diagram of an example device 1400 which may be used to implement one or more features described herein. In one example, device 1000 may be used to implement a client device, e.g., any of client devices 120-126 shown in FIG. 1. Alternatively, device 1000 can implement a server device, e.g., server device 104. In some implementations, device 1000 may be used to implement a client device, a server device, or both client and server devices. Device 1000 can be any suitable computer system, server, or other electronic or hardware device as described above.

One or more methods described herein can operate in several environments and platforms, e.g., as a standalone computer program that can be executed on any type of computing device, as a web application having web pages, a program run on a web browser, a mobile application (“app”) run on a mobile computing device (e.g., cell phone, smart phone, tablet computer, wearable device (wristwatch, armband, jewelry, headwear, virtual reality goggles or glasses, augmented reality goggles or glasses, head mounted display, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

In some implementations, device 1000 includes a processor 1002, a memory 1004, and input/output (I/O) interface 1006. Processor 1002 can be one or more processors and/or processing circuits to execute program code and control basic operations of the device 1000. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality (e.g., one or more hardware image decoders and/or video decoders), a special-purpose processor to implement neural network model-based processing, neural circuits, processors optimized for matrix computations (e.g., matrix multiplication), or other systems. In some implementations, processor 1002 may include one or more co-processors that implement neural-network processing. In some implementations, processor 1002 may be a processor that processes data to produce probabilistic output, e.g., the output produced by processor 1002 may be imprecise or may be accurate within a range from an expected output. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1004 is typically provided in device 1000 for access by the processor 1002, and may be any suitable processor-readable storage medium, such as random access memory (RAM), read-only memory (ROM), Electrical Erasable Read-only Memory (EEPROM), Flash memory, etc., suitable for storing instructions for execution by the processor, and located separate from processor 1002 and/or integrated therewith. Memory 1004 can store software operating on the server device 1000 by the processor 1002, including an operating system 1008, image application 1010 (e.g., which may be image application 106 of FIG. 1), other applications 1012, and application data 1014. Other applications 1012 may include applications such as a data display engine, web hosting engine, map applications, image display engine, notification engine, social networking engine, media display applications, communication applications, web hosting engines or applications, media sharing applications, etc. In some implementations, the image application 1010 can include instructions that enable processor 1002 to perform functions described herein, e.g., some or all of the methods of FIGS. 2-5 and/or 10-12. In some implementations, images stored in the formats described herein (including recovery maps, metadata, etc.) can be stored as application data 1014 or other data in memory 1004, and/or on other storage devices of one or more other devices in communication with device 1000. In some examples, image application 1010, or other applications stored in memory 1004, can include an image encoding/video encoding and container creation module(s) (e.g., performing methods of FIGS. 2-4) and/or an image decoding/video decoding module(s) (e.g., performing the methods of FIG. 5), or such modules can be integrated into fewer or a single module or application.

Any software in memory 1004 can alternatively be stored on any other suitable storage location or computer-readable medium. In addition, memory 1004 (and/or other connected storage device(s)) can store one or more messages, one or more taxonomies, electronic encyclopedia, dictionaries, digital maps, thesauruses, knowledge bases, message data, grammars, user preferences, and/or other instructions and data used in the features described herein. Memory 1004 and any other type of storage (magnetic disk, optical disk, magnetic tape, or other tangible media) can be considered “storage” or “storage devices.”

I/O interface 1006 can provide functions to enable interfacing the server device 1000 with other systems and devices. Interfaced devices can be included as part of the device 1000 or can be separate and communicate with the device 1000. For example, network communication devices, storage devices (e.g., memory and/or database), and input/output devices can communicate via I/O interface 1006. In some implementations, the I/O interface can connect to interface devices such as input devices (keyboard, pointing device, touchscreen, microphone, camera, scanner, sensors, etc.) and/or output devices (display devices, speaker devices, printers, motors, etc.).

Some examples of interfaced devices that can connect to I/O interface 1006 can include one or more display devices 1020 that can be used to display content, e.g., images, video, and/or a user interface of an application as described herein. Display device 1020 can be connected to device 1000 via local connections (e.g., display bus) and/or via networked connections and can be any suitable display device. Display device 1020 can include any suitable display device such as an LCD, LED, or plasma display screen, CRT, television, monitor, touchscreen, 3-D display screen, or other visual display device. Display device 1020 may also act as an input device, e.g., a touchscreen input device. For example, display device 1020 can be a flat display screen provided on a mobile device, multiple display screens provided in glasses or a headset device, or a monitor screen for a computer device.

The I/O interface 1006 can interface to other input and output devices. Some examples include one or more cameras which can capture images and/or detect gestures. Some implementations can provide a microphone for capturing sound (e.g., as a part of captured images, voice commands, etc.), a radar or other sensors for detecting gestures, audio speaker devices for outputting sound, or other input and output devices.

For ease of illustration, FIG. 10 shows one block for each of processor 1002, memory 1004, I/O interface 1006, and software blocks 1008-1014. These blocks may represent one or more processors or processing circuitries, operating systems, memories, I/O interfaces, applications, and/or software modules. In other implementations, device 1000 may not have all of the components shown and/or may have other elements including other types of elements instead of, or in addition to, those shown herein. While some components are described as performing blocks and operations as described in some implementations herein, any suitable component or combination of components of environment 100, device 1000, similar systems, or any suitable processor or processors associated with such a system, may perform the blocks and operations described.

Methods described herein can be implemented by computer program instructions or code, which can be executed on a computer. For example, the code can be implemented by one or more digital processors (e.g., microprocessors or other processing circuitry) and can be stored on a computer program product including a non-transitory computer-readable medium (e.g., storage medium), such as a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

Although the description has been described with respect to particular implementations thereof, these particular implementations are merely illustrative, and not restrictive. Concepts illustrated in the examples may be applied to other examples and implementations.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

1. A computer-implemented method comprising:
obtaining a first image depicting a particular scene, the first image having a first dynamic range;
obtaining a second image depicting the particular scene, the second image having a second dynamic range that is lower than the first dynamic range;
generating a recovery map based on the first image and the second image, wherein the recovery map encodes gains in luminances between portions of the first image and corresponding portions of the second image, the gains scaled by a range scaling factor that is based on a ratio of a maximum luminance of the second image to a maximum luminance of the first image; and
providing the first image and the recovery map in an image container, wherein the image container is readable to display a derived image based on applying the recovery map to the first image, wherein the derived image has a dynamic range that is lower than the first dynamic range.

2. (canceled)

3. (canceled)

4. (canceled)

5. The method of claim 1, wherein generating the recovery map includes encoding the gains in luminances such that applying the gains to luminances of individual pixels of the first image results in pixels corresponding to the second image.

6. The method of claim 5, wherein generating the recovery map includes encoding the gains in a logarithmic space, and wherein recovery map values are proportional to a difference of logarithms of the luminances divided by a logarithm of the range scaling factor.

7. The method of claim 5, wherein generating the recovery map is based on:
$$recovery ( x , y ) = log ( pixel\_gain ( x , y ) ) / log ( range scaling factor ) ,$$
wherein recovery(x,y) is the recovery map for pixel position (x, y) of the second image, and pixel_gain(x,y) is a ratio of luminances at a position (x, y) of the second image to the first image.

8. The method of claim 1, wherein generating the recovery map includes encoding the recovery map into a bilateral grid, wherein the encoding includes determining a three-dimensional data structure of grid cells, wherein each grid cell is a vector element that is mapped to multiple pixels of the first image.

9. The method of claim 1, further comprising encoding the recovery map into a recovery image, wherein providing the recovery map in the image container includes providing the recovery image in the image container, and wherein encoding the recovery map into the recovery image includes encoding the range scaling factor into the recovery image as metadata.

10. (canceled)

11. The method of claim 1, further comprising:
obtaining the image container;
determining to display the second image by a display device;
scaling a plurality of pixel luminances of the first image in the image container based on a particular luminance output of the display device and based on the recovery map to obtain the derived image; and
after the scaling, causing the derived image to be displayed by the display device as an output image that has a different dynamic range than the first image.

12. The method of claim 11, further comprising determining a maximum luminance display capability of the display device, wherein scaling the plurality of pixel luminances includes increasing luminances of highlights in the first image to a luminance level that is less than or equal to the maximum luminance display capability.

13. (canceled)

14. The method of claim 1, wherein obtaining the second image comprises performing range compression on the first image.

15. The method of claim 1, wherein the image container is readable to:
display the first image by a first display device capable of displaying the first dynamic range; and
display the derived image by a second display device only capable of displaying a dynamic range lower than the first dynamic range.

16. A computer-implemented method comprising:
obtaining an image container that includes:
a first image having a first dynamic range; and
a recovery map that encodes gains of pixels of the first image that are scaled by a range scaling factor that includes a ratio of a maximum luminance of a second image to a maximum luminance of the first image, wherein the second image corresponds to the first image in depicted subject matter and has a second dynamic range that is lower than the first dynamic range;
determining whether to display one of: the first image or a derived image having a dynamic range lower than the first dynamic range; and
in response to determining to display the first image:
causing the first image to be displayed by a display device; and
in response to determining to display the derived image:
applying the gains of the recovery map to luminances of pixels of the first image to determine respective corresponding pixel values of the derived image; and
causing the derived image to be displayed by the display device.

17. (canceled)

18. The method of claim 16, further comprising determining a maximum luminance display capability of the display device, wherein determining to display the first image is in response to determining that the display device is capable of displaying only a display dynamic range that is greater than the first dynamic range, and determining to display the derived image is in response to determining that the display device is capable of displaying a display dynamic range that is equal to or less than the first dynamic range.

19. (canceled)

20. (canceled)

21. The method of claim 16, wherein the dynamic range of the derived image has a maximum that is the lesser of:
a maximum luminance of the display device, and
a maximum luminance of a dynamic range of the second image.

22. The method of claim 16, wherein applying the gains of the recovery map to the luminances of the pixels of the first image includes:
scaling the luminances of the first image based on a particular luminance output of the display device and based on the recovery map.

23. The method of claim 16, wherein the scaling of the luminances of the first image is performed based on:
$$derived\_image ( x , y ) = first\_image ( x , y ) + log ( display\_factor ) * recovery ( x , y )$$
wherein derived_image(x,y) is a logarithmic space version of the derived image, first_image(x,y) is a logarithmic space version of the first image recovered from the image container, display_factor is a minimum of: the range scaling factor and a maximum display luminance of the display device, recovery(x,y) is the recovery map for pixel position (x, y) of the first image, and the range scaling factor is a ratio of a maximum luminance of the second image to a maximum luminance of the first image.

24. The method of claim 16, further comprising, in response to determining to display the derived image, decoding the range scaling factor from the image container.

25. (canceled)

26. The method of claim 16, further comprising:
extracting the recovery map from a bilateral grid stored in the image container.

27. The method of claim 16, wherein:
determining whether to display one of: the first image or the derived image is performed by a server device, the determination based on a display dynamic range of the display device that is included in or coupled to a client device;
causing the first image to be displayed by the display device includes sending the first image from the server device to the client device such that the client device displays the first image; and
causing the derived image to be displayed by the display device includes sending the derived image from the server device to the client device such that the client device displays the derived image.

28. The method of claim 16, wherein causing the derived image to be displayed by the display device includes reducing a maximum luminance level of the displayed derived image based on a system setting of a device that causes the derived image to be displayed, wherein the system setting is selected by a user.

29. (canceled)

30. A system comprising:
a processor; and
a memory coupled to the processor, with instructions stored thereon that, when executed by the processor, cause the processor to perform operations comprising:
obtaining an image container that includes:
a first image having a first dynamic range; and
a recovery map that encodes gains of pixels of the first image, wherein the recovery map encodes the gains of the pixels of the first image that are scaled by a range scaling factor that includes a ratio of a maximum luminance of a second image to a maximum luminance of the first image, wherein the second image corresponds to the first image in depicted subject matter and has a second dynamic range that is lower than the first dynamic range;
determining to display a derived image on a display device, wherein the derived image corresponds to the first image in depicted subject matter and has a dynamic range that is lower than the first dynamic range; and
in response to determining to display the derived image on the display device:
applying the gains of the recovery map to luminances of pixels of the first image to determine respective corresponding pixel values of the derived image, wherein applying the gains includes scaling the luminances of the first image based on a particular luminance output of the display device and based on the recovery map; and
causing the derived image to be displayed by the display device.

31. (canceled)

32. (canceled)

33. (canceled)
